(19) United States
(12) Patent Application Publication
(10) Pub. No.: US 2013/0067629 A1
(43) Pub. Date: Mar. 21, 2013

(54) FAST DRYING CELLULOSIC FABRIC AND PROCESS TO PRODUCE SAME

(71) Applicant: Optimer, Inc., Wilmington, DE (US)

(72) Inventors: Christopher S. Moore, Wilmington, DE (US); Bhalchandra Dhamankar, Newark, NJ (US); Ashwinkumar Jaju, New Castle, DE (US)

(73) Assignee: OPTIMER, INC., Wilmington, DE (US)

(21) Appl. No.: 13/622,405

(22) Filed: Sep. 19, 2012

Related U.S. Application Data
(60) Provisional application No. 61/536,825, filed on Sep. 20, 2011.

(51) Int. Cl. D06M 15/263; C09D 131/04; C09D 127/18; A43B 17/00; C09D 129/06; A41B 1/00; A41B 9/00; B32B 23/02; C08L 31/04

(52) U.S. Cl. 2/69; 8/115.6; 524/502; 524/1; 524/500; 524/520; 524/524; 524/503; 2/400; 2/239

(57) ABSTRACT

Cellulosic fabrics and articles are disclosed that include a treatment to provide the fabric that has a balance of comfort, absorbency, wicking, and fast drying. Methods to produce the fabrics and articles are also disclosed.

### CROSS REFERENCE TO RELATED APPLICATIONS

This application claims the benefit of U.S. Application No. 61/536,825, filed Sep. 20, 2011, the entire disclosure of which is incorporated herein by reference.

### FIELD OF THE INVENTION

The invention relates to fabrics, and especially cellulosic fabrics that comprise a treatment to render the fabric fast drying and methods to produce the same.

### BACKGROUND OF THE INVENTION

Fast drying fabrics comprising cellulosic yarns provide garment benefits in the areas of active sports, outdoor work, recreational activities, military and other uses for example, where the rate of perspiration is high. In some cases, fabric is treated with a water resistant chemical to a degree that the entire fabric becomes water resistant or hydrophobic. In other cases, a blend of cellulosic and synthetic yarns is incorporated into the fabric to provide improved water resistance and in some configurations, more rapid drying rates. These fabrics however, do not have the appearance, ability to wick quickly, or comfortable feel of untreated cellulosic fabrics. In addition, these fabrics are typically treated with a hydrophobic chemical, or are blended with a synthetic fiber or hydrophobic treated yarn that does not absorb water, which reduces the overall ability of the fabric to absorb water compared to an untreated fabric. These fabrics therefore, do not absorb water to the degree of an untreated cellulosic fabric. Therefore, these fabrics do not sufficiently absorb water and are not well suited for drying applications, such as towels, for example.

Thus, there exists a need for a fabric that has the appearance and feel of untreated cellulosic fabric, has a water weight gain similar to an untreated cellulosic fabric, is hydrophilic to provide wicking of sweat and is fast drying. The invention is directed to these, as well as other, important needs.

### SUMMARY OF THE INVENTION

The invention is directed to a fabric comprising a treatment that renders the fabric fast drying and hydrophilic. The treatment comprises a chemically bonded treatment portion and a physically attached hydrophobic particle treatment portion. The treatment is applied in such low concentrations that the fabric remains hydrophilic and retains the look and feel of the untreated base fabric. The unique combination of the two treatment portions in the range of concentration described herein, surprising renders fabric fast drying, while not substantially changing the water weight gain performance from that of the base, untreated fabric. In one embodiment the fabric comprises a cellulosic material, and in another embodiment the fabric consists essentially of a cellulosic material, such as cotton.

Accordingly, in one embodiment, the invention is directed to articles of manufacture, comprising:
a fabric, comprising at least about 45%, by weight, based on the total weight of the fabric, of at least one cellulosic material;
a treatment to form a treated fabric, wherein said treatment comprises:
   a hydrophobic particle treatment portion; and
   a chemically bonded treatment portion;
wherein said treated fabric is hydrophilic and fast drying.

In another embodiment, the invention is also directed to processes for producing an article, comprising:
providing a fabric;
wherein said fabric comprises at least about 45%, by weight, based on the total weight of the fabric, of at least one cellulosic material;
providing a hydrophobic particle treatment;
providing a chemical treatment;
wherein said chemical treatment comprises:
at least one hydrophilic monomer or polymer having a moiety reactive with a hydroxyl group on said cellulosic material;
at least one hydrophobic fluoropolymer or fluoromonomer; and
at least one optional catalyst;
treating said fabric with said hydrophobic particle treatment at a level of about 0.05% by weight of dried solids to about 2% by weight of dried solids, based on the total weight of the fabric, and said chemical treatment at a level of about 3% by weight to about 10% by weight, based on the total weight of the fabric, to form a treated fabric;
optionally, padding said treated fabric; and
optionally, curing said treated fabric.

In further embodiments, the invention is directed to compositions, comprising:
a. a plurality of hydrophobic particles;
b. at least one hydrophilic monomer or polymer having a moiety reactive with a hydroxyl group;
c. at least one hydrophobic fluoropolymer or fluoromonomer;
d. optionally, at least one catalyst; and
e. optionally, water, alcohol solvent, or combinations thereof.

The hydrophobic particle treatment portion comprises hydrophobic particles such as fluoropolymer particles, including but not limited to polytetrafluoroethylene (PTFE). The hydrophobic particle may be very small, such as less than about 10 μm, preferably, less than about 10 μm, and more preferably, less than about 500 nm. In addition, the particles may comprise high molecular weight fluoropolymer, such as PTFE, that are relatively deformable and in some embodiments may fibrillate when sheared. The particles are physically attached to the fiber and/or trapped in the yarns and in the fabric through a treatment process including in some embodiments a squeezing or padding process step whereby the fabric is compressed after being treated with the hydrophobic particles.

The chemically bonded portion described herein is chemically bonded to the hydroxyl groups of the cellulosic material. The chemically bonded portion may comprise a hydrophilic portion and/or hydrophobic portion. The chemically bonded portion may be a linear compound or polymer. The relatively low amount of chemically bonded treatment portion provides for more effective water release, and faster drying times. The hydrophobic portion of the chemically bonded treatment portion may comprise a fluorine group, or fluoropolymer, and the bonding portion may comprise a urethane or an acid, or any other reactive site that will bind or chemically react to the hydroxyl groups of the fabric surface. The chemically bonded portion may be bonded to the fabric with the aid of a catalyst, such as but not limited to metal salts (such as, for example magnesium chloride, potassium chloride, antimony salt, or a combination thereof).

The cellulosic fabric described herein may be a knit, woven or non-woven and may be any suitable weight, or comprise any suitable denier or count of yarn. For example, the base fabric may consist essentially of a cotton yarn in a woven, knit, or nonwoven structure. In another embodiment, the fabric may consist essentially of cellulose, or cellulosic derivatives, such as cotton, fire-resistant cotton, viscose, linen, rayon, fire-resistant rayon, lyocell, or any combination thereof. The fabric may comprise a substantial amount of cellulosic material, that is, the fabric comprises at least 45% by weight cellulosic material. The fabric may comprise any weight percentage of cellulosic material above 45%, such as more than about 50%, more than about 60%, more than about 65%, or more than about 75%. In one embodiment, the fabric comprises about 50% by weight polyester and about 50% by weight cotton, or some other cellulosic material. In another embodiment the fabric is comprised of about 35% by weight polyester and about 65% by weight cotton, or some other cellulosic material. The fabric described herein may consist essentially of cellulose material or cellulosic derivative. For example, the yarns of the fabric may consist essentially of cellulose material or cellulosic derivatives, wherein the base fabric, excluding the treatment described herein or any other softeners or treatments, is made of only cellulosic material, such as cotton. In yet another embodiment, the fabric comprises yarns that have a blend of a cellulosic derivative material, or fiber, and a non-cellulosic material or fiber, such as a synthetic or polymeric fiber such as polyester.

The article described herein may be in the form of a garment, such as a shirt, pants, and especially an active wear garment, where fast drying of perspiration is beneficial. The article described herein may also be in the form of an undergarment, such as socks or underwear. The article may also be in the form of a drying or washing article, such as a towel or washcloth, or cleaning, or drying article. The article described herein may comprise fabric described herein or may be made essentially of the fabric described herein.

Typically, hot environments and intense activities are associated with higher outputs of sweat production. Fabrics that wick and have high water release rates will be better able to keep up with increased sweat production and will not become over saturated. In addition, once the wearer stops the activity, a fabric saturated with sweat begins to rob heat from the body causing chills as the environment cools. Even slightly higher water release rates (WRR) have an impact on comfort, as these are time-based measurements whose benefits accumulate over time. Fabrics with higher WRR and wicking help to remove body heat containing sweat from the skin, which can help to reduce core temperature. High WRR fabrics enable garments made from that fabric to dry quickly and restore the fabrics ability to provide dry insulation when sweat-producing activities cease.

The fabric described herein may be produced by a method that utilizes greige or dyed base fabrics consisting essentially of cellulosic yarns or fibers, and a treatment process that can be integrated into existing fabric producing or fabric finishing processes. In one embodiment, the method described herein is relatively low cost and an easily integrated process that can be implemented in line on many standard fabric finishing processes. In addition, the method described herein does not require the use of specially finished fiber or yarns. In addition, a dye and/or fabric softener may be applied to the fabric before, after, or during the treatment process described herein. The treatment process described herein comprises at least one treatment step, where the hydrophobic particles and/or chemically bonded treatment portion are applied to the fabric. This treatment step is followed by a drying step, and in some cases an additional heating step. A heating step may be used to provide energy necessary for chemically bonding the chemically bonded treatment portion with the hydroxyl groups on the base fabric. The two treatment portions may be applied in any suitable manner and may be applied in separate steps to the fabric or to yarns of the fabric. The treated fabric may be passed through a compression process, such as a nip rollers, or belts, where a portion of the treatment formulation is squeezed out of the fabric. The fabric may then be subjected to elevated temperatures in any conventional way to drive off any treatment formulation or excess liquid, or water. The heat treatment process may be used such as a conventional oven or tunnel dryer.

The summary is provided as a general introduction to some of the embodiments of the invention, and is not intended to be limiting. Additional example embodiments, including variations and alternative configurations of the invention as well as combinations of embodiments are provided herein.

### BRIEF DESCRIPTION OF THE DRAWINGS

The accompanying drawings are included to provide a further understanding of the invention and are incorporated in and constitute a part of this specification, illustrate embodiments of the invention and together with the description serve to explain the principles of the invention.

FIG. 1A shows the intersection of warp and weft yarns of a fabric having physically attached hydrophobic particles and a chemically bonded treatment portion.

FIG. 1B shows an example of a knit fabric having physically attached hydrophobic particles and a chemically bonded treatment portion.

FIG. 1C shows yarns having fiber blends, and warp and weft yarns of a fabric having physically attached hydrophobic particles and a chemically bonded treatment portion.

FIG. 1D shows a representation of a fabric surface having hydroxyl groups and chemically bonded treatment portions that extend away from the surface of the fabric.

FIGS. 2A and 2B show diagrams of processes for producing the fabric described herein.

FIGS. 3A and 3B show a scanning electron micrograph (SEM) of a fiber having physically attached hydrophobic particles of the present invention.

FIG. 4 shows a bar graph of Water Weight Gain of knit cotton fabrics described herein, a control knit cotton fabric and the comparative fabrics A and B, before and after wash cycles.

FIG. 5A shows a bar graph of Comfort Zone WRR of knit cotton fabrics described herein, a control knit cotton fabric and the comparative fabrics A before and after wash cycles.

FIG. 5B shows a bar graph of Total WRR of knit cotton fabrics described herein, a control knit cotton fabric and the comparative fabrics A before and after wash cycles.

FIG. 6A shows a bar graph of Comfort Zone dry time of knit cotton fabrics described herein, a control knit cotton fabric and the comparative fabrics A before and after wash cycles.

FIG. 6B shows a bar graph of Total Dry Time of knit cotton fabrics described herein and a control knit cotton fabric before and after wash cycles.

FIG. 7A shows a bar graph of Comfort Zone WRR of woven cotton fabrics described herein and a control woven cotton fabric.

FIG. 7B shows a bar graph of Total WRR of woven cotton fabrics described herein and a control woven cotton fabric.

FIG. 8A shows a bar graph of Comfort Zone dry time of woven cotton fabrics described herein and a control woven cotton fabric.

FIG. 8B shows a bar graph of Total Dry Time of woven cotton fabrics described herein and a control woven cotton fabric.

FIG. 9A shows a bar graph of Comfort Zone WRR of 50/50 polyester/cotton fabrics described herein and a control 50/50 Poly/Cotton fabric.

FIG. 9B shows a bar graph of Total WRR of 50/50 polyester/cotton fabrics described herein and a control 50/50 polyester/cotton fabric.

FIG. 10A shows a bar graph of Comfort Zone dry time of 50/50 polyester/cotton fabrics described herein and a control 50/50 polyester/cotton fabric.

FIG. 10B shows a bar graph of Total Dry Time of 50/50 polyester/cotton fabrics described herein and a control 50/50 polyester/cotton fabric.

FIG. 11A shows a bar graph of the Comfort Score of the knit cotton fabrics described herein, the control knit cotton fabric, and two comparative fabrics.

FIG. 11B shows a bar graph of the Comfort Score of the woven cotton fabrics described herein, and the control woven cotton fabric.

FIG. 11C shows a bar graph of the Comfort Score of the 50/50 polyester/cotton fabrics described herein, and the 50/50 polyester/cotton control fabric.

FIG. 12A shows a representation of a woven comparative fabric having two different warp and weft yarns, wherein only the weft yarn has a hydrophobic treatment.

FIG. 12B shows a representation of a comparative knit fabric, having only some of the yarns treated with a hydrophobic treatment.

### DETAILED DESCRIPTION OF THE INVENTION

As employed above and throughout the disclosure, the following terms, unless otherwise indicated, shall be understood to have the following meanings.

As used herein, the singular forms “a,” “an,” and “the” include the plural reference unless the context clearly indicates otherwise.

The use of numerical values in the various quantitative values specified in this application, unless expressly indicated otherwise, are stated as approximations as though the minimum and maximum values within the stated ranges were both preceded by the word “about.” In this manner, slight variations from a stated value can be used to achieve substantially the same results as the stated value. Also, the disclosure of ranges is intended as a continuous range including every value between the minimum and maximum values recited as well as any ranges that can be formed by such values. Also disclosed herein are any and all ratios (and ranges of any such ratios) that can be formed by dividing a recited numeric value into any other recited numeric value. Accordingly, the skilled person will appreciate that many such ratios, ranges, and ranges of ratios can be unambiguously derived from the numerical values presented herein and in all instances such ratios, ranges, and ranges of ratios represent various embodiments of the present invention.

As used herein, the term “physical bond” refers to a mechanical connection or contacting, interference, filtration trapping, or secondary chemical bond (like van der Waals forces, hydrogen bonding, or where attraction exists between the particle and a surface but where no electron sharing or transfer occurs).

As used herein, the term “chemical bond” refers to a bond that holds the chemically bonded treatment portion durably to the fabric surface. A typical example is a primary bond formed from the reaction of a urethane or an acid, for example, and a hydroxyl (—OH group) naturally present in cellulosic materials, such as cotton. Other examples include an acid reaction or a hydration reaction of a double bond.

As used herein, the term “treatment” refers to a combination of a hydrophobic particle treatment portion and a chemically bonded treatment portion as described herein.

As used herein with reference to an article of manufacture, the term “hydrophilic” as used herein in reference to the article of manufacture of the invention, refers to an article that has a horizontal wicking time of no more than about 8 seconds, preferably no more than about 5 seconds, and even more preferably no more than about 3 seconds.

As used herein with reference to an article of manufacture, the term “fast drying” refers to an article having a comfort zone dry time at least about 10% faster than a control article. The article described herein may have a single or an average comfort zone dry time at least about 10% faster, preferably about 15%, even more preferably about 30%, yet more preferably about 50% or even further more preferably about 65% faster than a control article. A “control article” is an article having substantially the same construction and composition as the treated article described herein without the treatment described herein. This may be expressed using the following equation:

$$\% Improvement DT = 100 \times \frac{( \begin{matrix}control fabric dry time - \\ treated fabric dry time\end{matrix} )}{control fabric dry time}$$

As used herein, the term “total dry time” refers to the time an article takes to dry from full saturation (article is submerged in water and padded with AATCC padding paper) to a saturation of 2% water content.

As used herein, the term “comfort dry time” refers to the time an article takes to dry from 20% by weight water content to 2% by weight water content. This 20% water content was based upon subjective testing and serves as a more realistic “wetness” level in garments exposed to sweat than full saturation.

As used herein, the term “water release rate” (WRR) refers to the percentage of water released from the fabric per minute in a controlled environment using a modified version of the provisional AATCC Gravimetric Drying Test Method (AATCC/MM TS-05) using multiple scales and multiple sample measurements for better accuracy of sample weights.

As used herein, the term “comfort score” refers to a performance score that quantifies ability of an article to absorb water and dry rapidly. The comfort score is the ratio of the water weight gain percent over the comfort zone dry time in minutes. The average comfort score reported herein is the average calculated for the fabrics before washing.

As used herein, the term “garment,” as used herein, refers to any article of clothing or clothing accessory worn by a person, including, but not limited to shirt, pants, underwear, outer wear, footwear, headwear, swimwear, workwear, uniforms, belts, gloves, socks, headbands, wristbands, sports specific activity apparel such as karate uniforms, and especially those used as protective wear or gear.

As used herein, the term “linen,” as used herein refers to any article of fabric or material used on a bed or similar furniture, including, but not limited to a sheet, pillowcase, blanket, throw, afghan, sleeping bag, baby bunting, quilt, comforter, mattress cover, and the like.

While the present invention is capable of being embodied in various forms, the description below of several embodiments is made with the understanding that the present disclosure is to be considered as an exemplification of the invention, and is not intended to limit the invention to the specific embodiments illustrated. Headings are provided for convenience only and are not to be construed to limit the invention in any manner. Embodiments illustrated under any heading may be combined with embodiments illustrated under any other heading.

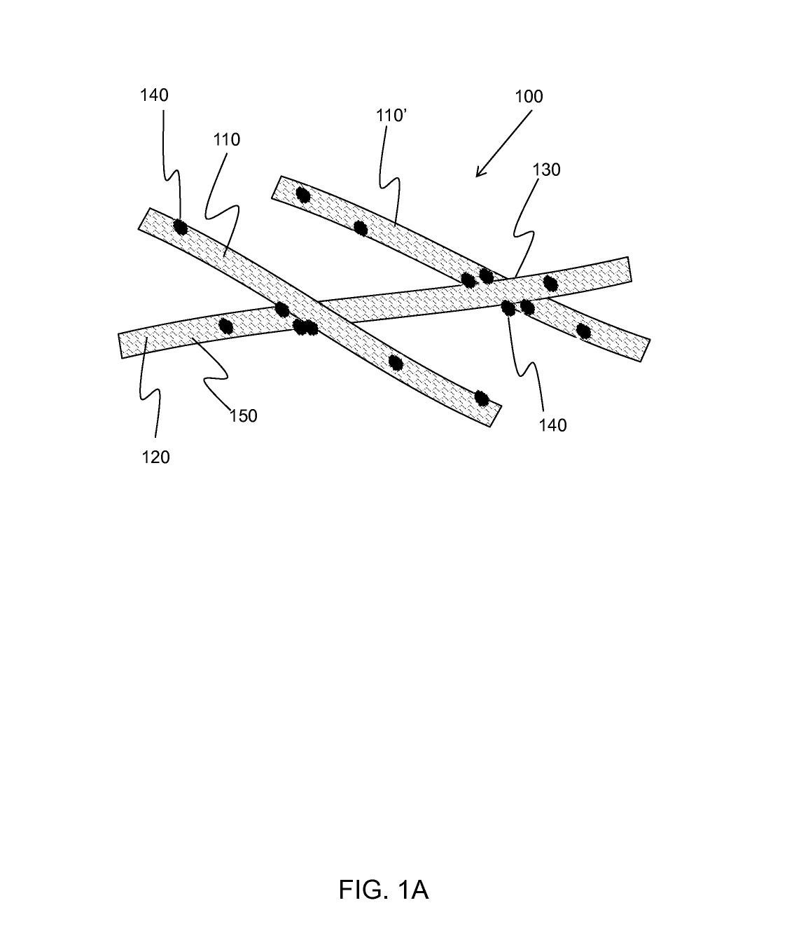

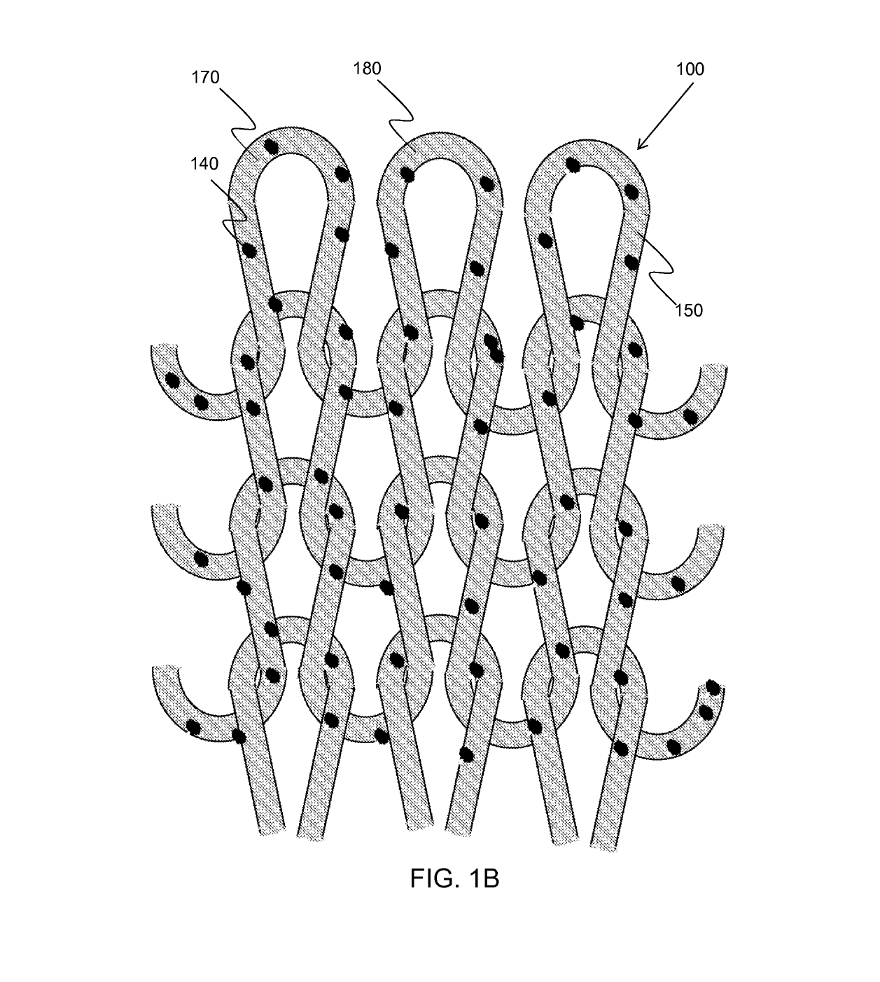

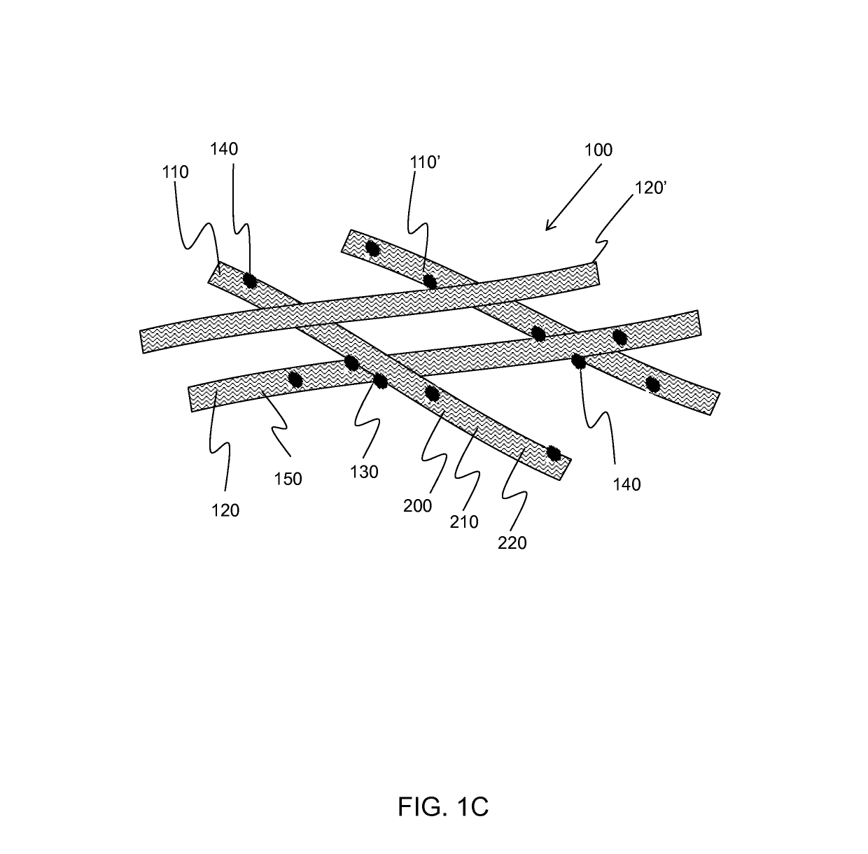

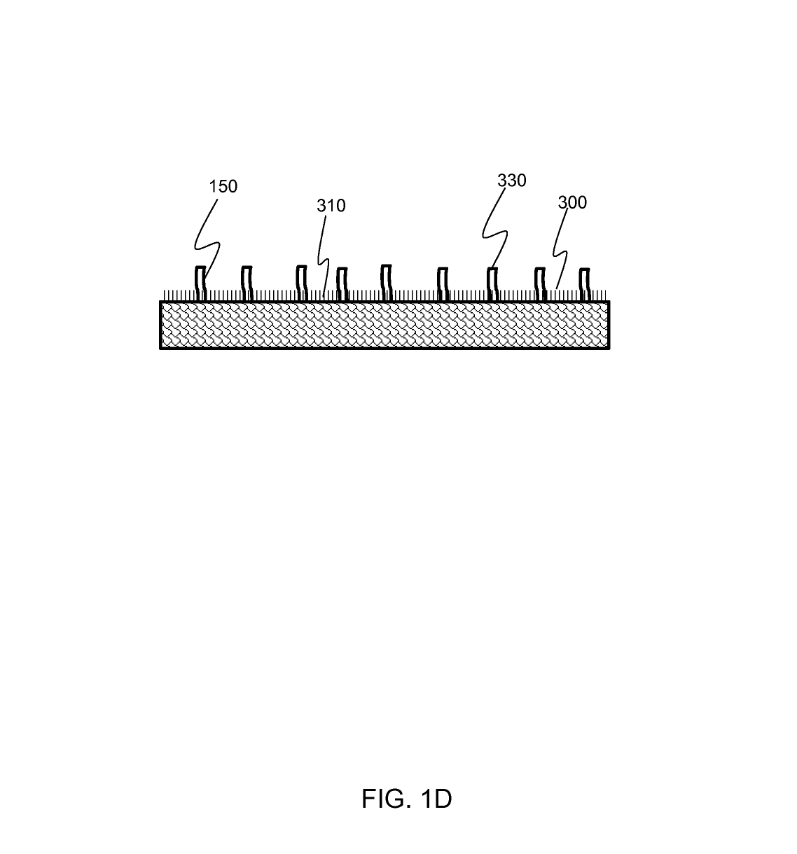

The fabric described herein comprises a treatment that renders the fabric fast drying and hydrophilic. The fabric 100 shown in FIG. 1A comprises warp 110 and weft yarns 120 that have intersections 130 where the hydrophobic particle treatment portion 140 may concentrate. The chemically bonded treatment portion 150 may be uniformly distributed over the fiber, yarn, or fabric surface as depicted by the fill lines on the yarns in FIG. 1A. As used herein with respect to the chemically bonded treatment portion, the term “uniform” refers the presence of the treatment through or over substantially the entire surface or thickness of the fabric on a macroscopic level, rather than be present only on a single surface or on discrete portions on the surface. It should be understood that the distribution may still be “uniform,” even if the chemically bonded treatment portion is randomly located at the microscopic level. Additionally, the hydrophobic particle treatment portion 140 may be located along the fiber or yarn surface. FIG. 1B shows a knit fabric construction 170, with interlocking loops of knit yarns 180.

FIG. 1C shows the intersection of yarns 220 that are comprised of a blend of fibers. The yarns depicted in FIG. 1C have a first 200 and second fiber 210 blended into the yarn as indicated by the wavy fill lines on the yarns. The fibers may be, for example, randomly and intimately blended into the yarns. The yarns could be any suitable blend, and in one embodiment, the blend comprises at least one cellulosic material. The blended fiber yarn 220, may comprise at least 45% by weight cellulosic material, such as cotton, and may comprise a polymeric fiber material. The fabric comprising blended fiber yarns as shown is FIG. 1C comprises a treatment as described herein. The treatment as described herein, is depicted as a chemically bonded treatment portion 150, and a hydrophobic particle treatment portion 140, in FIG. 1C.

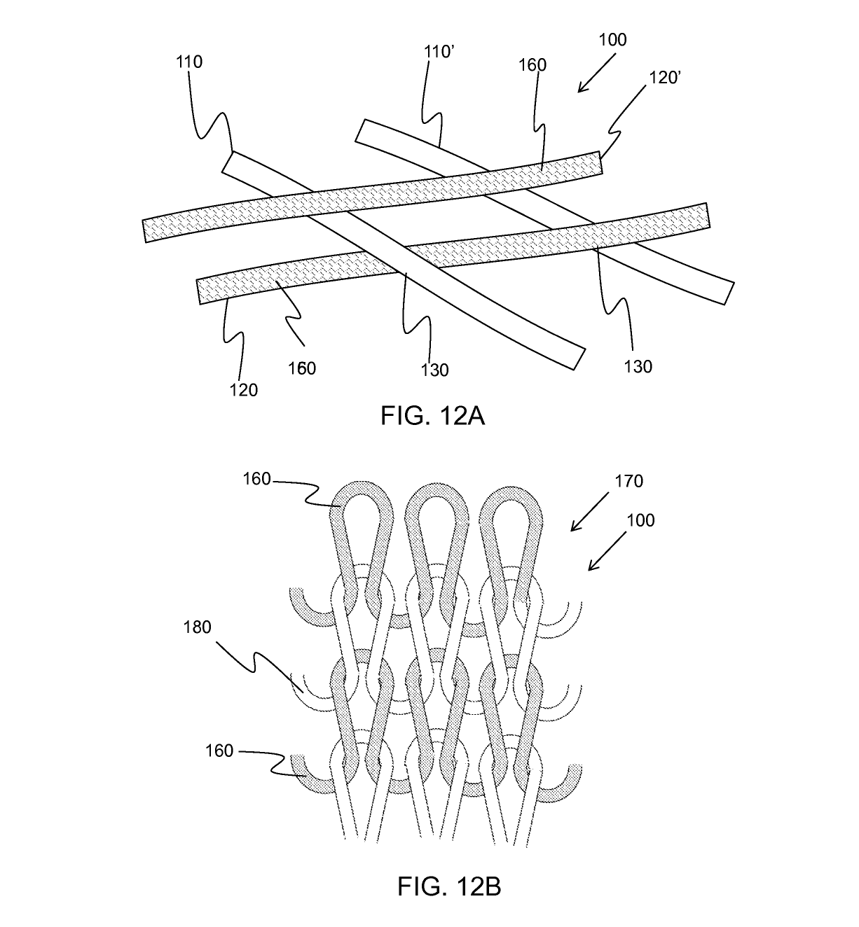

FIGS. 1A, 1B, and 1C depict uniform fabrics where all the yarns of the fabric are comprised of the same compositional materials. A uniform fabric as defined herein, is a fabric constructed of a single compositional yarn. For example, the yarn may consist essentially of cotton or another cellulosic material. In an alternative uniform fabric embodiment, the yarn may be comprised of a blend of materials, such as an intimate blend of two or more compositionally dissimilar fibers. In another embodiment, the fabric comprises compositionally different yarns, however all the yarns consist essentially of cellulosic material. A comparative fabric that is not uniform as defined herein, is depicted in FIG. 12A, where the weft yarns 120 and warp yarns 110 are compositionally different. As shown in FIG. 12A, only the weft yarns comprise a hydrophobic treatment 160. Likewise as shown in FIG. 12B, a comparative knit fabric 170 has a non-uniform fabric construction, where only a portion of the yarns 180 are treated with a hydrophobic treatment 160. An example of a non-uniform fabric is provided in the comparative examples as transDRY™ fabric, available from Cotton Incorporated.

In one embodiment, the fabric described herein is hydrophilic, as defined by a fabric having a horizontal wicking time of no more than about 8 seconds. The hydrophilic fabric described herein may have a horizontal wicking time of no more than 5 seconds or no more than 3 seconds. The yarns of a knit fabric, warp or weft yarns of a woven fabric, or any yarns or fibers (if the fabric is made from a single compositional yarn), may be removed from a fabric and tested for horizontal wicking according to the test method described herein. In one embodiment, the fabric described herein is comprised essentially of yarns that are hydrophilic as defined herein.

As shown in FIG. 1D, the surface of the fabric, yarn or fiber may comprise a chemically bonded treatment portion 150. A cellulosic derivate material will comprise hydroxyl groups 310, some of which will be present at the surface 300 as depicted in FIG. 1D. The chemically bonded treatment portion may comprise one portion that reacts with the hydroxyl groups and another portion that extends from the reacted portion, such as away from the surface of the fiber or yarn. In one embodiment, the chemically bonded treatment portion comprises a linear polymer that has a first end that reacts with the hydroxyl group and a second end that extends from the surface of the fiber or fabric. The chemically bonded treatment portion may comprise a hydrophobic portion, such as at least one fluorine atom 330 as depicted in FIG. 1D and may comprises a plurality of fluorine atoms, especially in the end group, such as —CF₂ or —CF₃ groups.

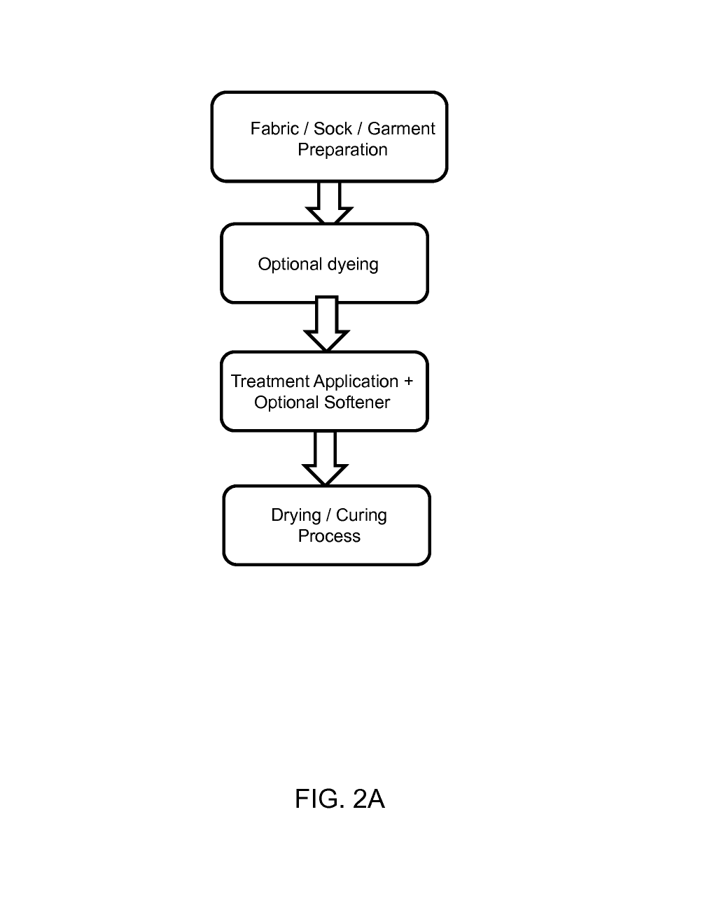

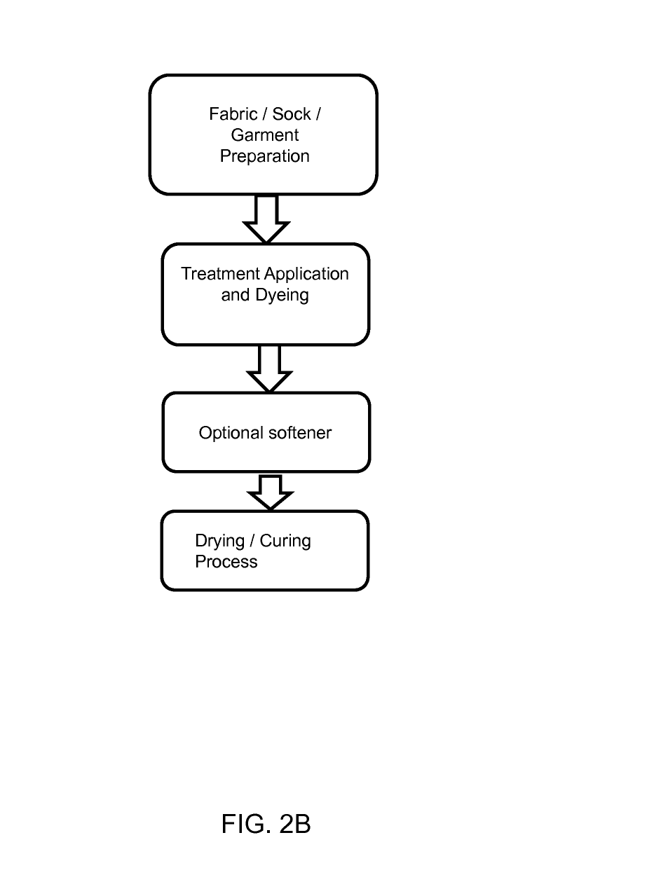

The treatment process may comprise mixing both the hydrophobic particle treatment portion and the chemically bonded treatment portion into a single treatment whereby the fabric may be coated, such as by dipping, spraying, soaking or any other suitable means. The treatment portions may also be applied separately, and the chemically bonded treatment portion may be applied and reacted before the hydrophobic particle treatment portion is applied, for example. In one embodiment both treatment portions are combined into one treatment bath and the fabric may be submerged in the bath, squeezed to remove any excess liquid, and then dried. The drying may cause the chemically bonded treatment portion to react with the fabric, or a separate heating step may be used to bond the chemically bonded treatment portion. FIG. 2A shows how the treatment process described herein may be integrated into a conventional finishing process (either dyeing followed by treatment or simultaneous softener, and/or other additions and treatment, as typically done in a padding process). As shown in FIG. 2B, the fabric may be treated with the treatment as described herein, during the dyeing or exhaust process. The fabric may be treated as described herein before or after the application and post processing of a dye or softener on the fabric. FIG. 2A shows treatment and the addition of optional softener after dyeing. FIG. 2B shows treatment during the dyeing process, with an optional softener with dye exhaust treatment (still in dyeing) or in a separate step following dyeing and treatment.

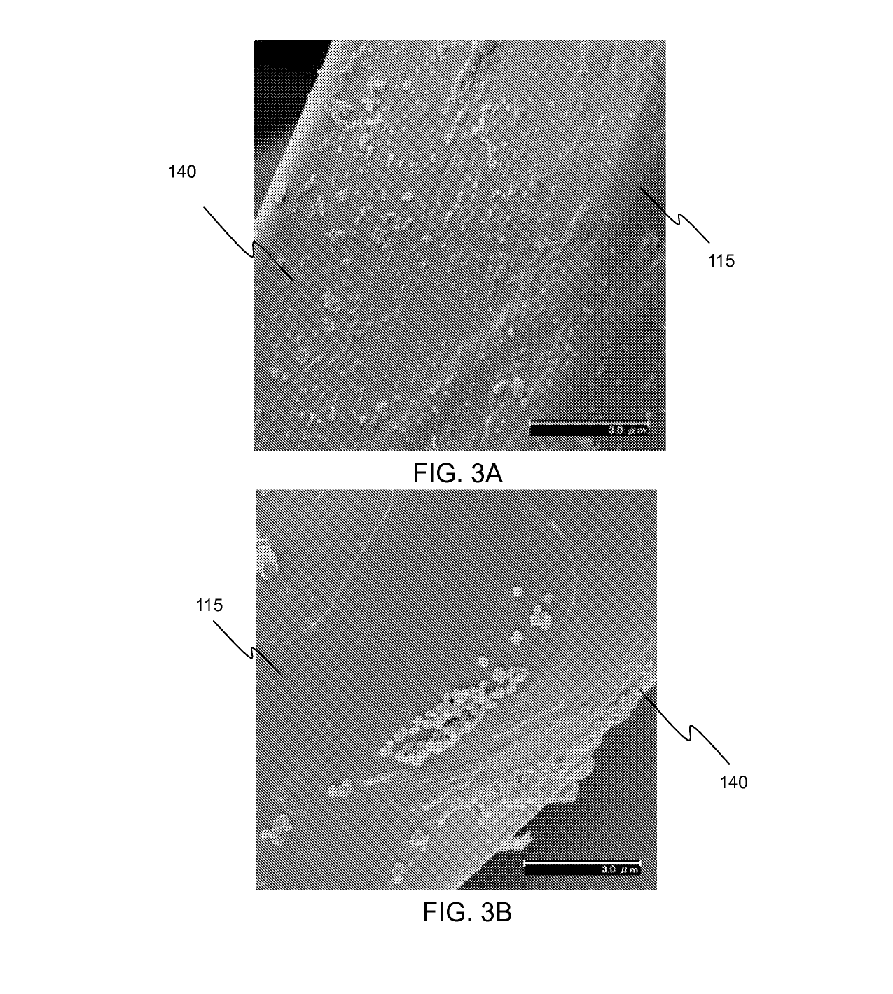

FIGS. 3A and 3B show SEMS of polyester fibers removed from the treated fabric with particles (from Example 1). The hydrophobic particles of the hydrophobic particle treatment portion are dispersed throughout and on the yarns. The scale bar on the SEMS is 3 μm in length. The hydrophobic particles are therefore much less than 1 μm in size. As shown more clearly in FIG. 3B, the particles are less than about 500 nm in size. In some embodiments, the hydrophobic particle treatment portion may be concentrated in the intersections of yarns as shown in FIG. 1A.

The treatment as described herein may be applied uniformly to the fabric. For example, the treatment may be applied to the entire fabric, such as through a dipping process. The hydrophobic particle treatment portion and chemically bonded treatment portion may be uniformly distributed throughout the fabric, and may not be substantially concentrated on one side of the fabric. As used herein, the term “uniformly distributed” in reference to the treatment, means that both the hydrophobic particle treatment portion and chemically bonded treatment portion are substantially uniformly distributed throughout the fabric and not concentrated or applied in such a way to produce a gradient in concentration, over the surface of the fabric or through the fabric. In another embodiment however, the treatment may be applied in such a way to produce a gradient of concentration from one side of the fabric to the other side.

Any suitable fabric may be treated with the hydrophobic particle treatment portion and chemically bonded treatment portion as described herein. In one embodiment, the fabric comprises cellulosic materials such as cellulose or cellulosic derivative materials including cotton, fire-resistant cotton, viscose, linen, rayon, fire-resistant rayon, lyocell, or a combination thereof. The fabric may comprise a substantial amount of cellulosic material, wherein the fabric comprises at least 45% by weight cellulosic material. The fabric may comprise any weight percentage of cellulosic material above 45%, such as more than about 50%, more than about 60%, more than about 65%, or more than about 75%. In one embodiment, the fabric is comprised of about 50% by weight polyester and about 50% by weight cotton, or some other cellulosic material. In another embodiment the fabric comprises about 35% by weight polyester and about 65% by weight cotton, or some other cellulosic material. The fabric described herein may consist essentially of cellulose or cellulosic derivative. For example, the yarns of the fabric may consist essentially of cellulose or cellulosic derivatives, wherein the base fabric, excluding the treatment described herein or any other softeners or treatments, is made of only cellulosic material, such as cotton. In one embodiment, the fabric is a knit consisting essentially of cotton yarns. Dyes or softeners within the fabric may be used in embodiments where the fabric consists essentially of cellulose or cellulosic derivative. In another embodiment, the fabric is woven comprising warp and weft yarns where the warp yarns consist of cotton and the weft yarns consists of lyocell. Any combination of yarn weights or cellulosic types may be incorporated into a fabric that, for the purposes of this invention, consists essentially of cellulosic material. In some embodiments, the treatment is applied to a uniform fabric, where the fabric consists of a single composition of yarn. For example, a woven fabric consisting of cotton yarns only, would be considered a uniform fabric.

The hydrophobic particle treatment portion may be any suitable hydrophobic particle and may comprise a polymer. Hydrophobic particles may comprise any suitable materials including but not limited to polymers, metals, glass, ceramic, and the like. In addition, combinations of materials may be used as the hydrophobic particles described herein. For example, a rigid hydrophobic polymer or material, such as silica may be entrained or otherwise incorporated into a softer polymeric material. In one embodiment, the hydrophobic particles consist essentially of a polymer, such as a fluoropolymer. In another embodiment, the particles consist of a fluoropolymer, such as PTFE. The PTFE may be a high molecular weight PTFE, such as a PTFE dispersion. The dispersion may be of a fine powder type PTFE, having a molecular weight of more than 100,000. PTFE is a chemically inert polymer and therefore does not chemically react with the fabric and is not chemically bonded to the fabric. However, PTFE especially high molecular weight, fine powder type PTFE, is known to fibrillate when sheared and is of a size that can be trapped and therefore may physically bond to a surface.

The hydrophobic particles of the hydrophobic particle treatment portion may have any suitable particle size such as no more than about 10 μm, no more than about 1 μm, no more than about 500 nm, no more than 100 nm, or any range between the specific values provided. The particle size and void fraction of the polymeric particles may be determined by conventional techniques known, including microscopy and the Brookhaven Model BI-90 Particle Sizer supplied by Brookhaven Instruments Corporation, Holtsville, N.Y., which employs a quasi-elastic light scattering technique to measure the size of the particles. The molecular weights of the polymers may be from about 100,000 to 5 million weight average, and most preferably, above 500,000.

The chemically bonded portion is chemically bonded to the hydroxyl groups of the cellulosic fabric and may comprise a hydrophilic portion and/or hydrophobic portion. The chemically bonded portion may be a linear compound or polymer. The relatively low amount of chemically bonded treatment portion provides for more effective water release, and faster drying times. The hydrophobic portion of the chemically bonded treatment portion may comprise a fluorine group, or fluoropolymer, and the bonding portion may comprise a urethane or acid, or any other reactive site that will bind or chemically react to the hydroxyl groups of the fabric surface. The chemically bonded portion may be bonded to the fabric with the aid of a catalyst, including but not limited to metal salts (such as, for example, magnesium chloride, potassium chloride, antimony salts, or a combination thereof.

In certain embodiments, the chemically bonded treatment portion is formed from a mixture comprising:

at least one hydrophilic polymer having a moiety reactive with a hydroxyl group on said cellulosic material; and

at least one hydrophobic fluoropolymer.

RAINOFF® SRL-1, available from Eastern Chemical Co. Providence, R.I., is an example of a suitable mixture for use in the articles of manufacture, processes, and compositions of the invention. Other examples include, but are not limited to, similar chemistries such as Unidyne 991, 992, and 993 available from Daikin, Zonyl 7910, 9815, 9933, and 9938 available from DuPont, Nanotex 603B and 604B, Repearl SR-1100 available from Mitsubishi, FC258 and PM490 available from 3M, NUVA SRL from Clariant, Baygard SOC and Baygard WSR from Bayer, Oleophobol ZSR from Ciba, and the like.

In certain embodiments, the hydrophilic polymer having a moiety reactive with a hydroxyl group on said cellulosic material is present at a level of about 10% by weight to about 90% by weight, based on the total weight of said mixture. In certain embodiments, the hydrophilic polymer having a moiety reactive with a hydroxyl group on said cellulosic material is present at a level of about 40% by weight to about 70% by weight, based on the total weight of said mixture. In certain embodiments, the hydrophilic polymer having a moiety reactive with a hydroxyl group on said cellulosic material is present at a level of about 70% by weight to about 90% by weight, based on the total weight of said mixture.

In certain embodiments, the hydrophobic fluoropolymer is present at a level of about 10% by weight to about 90% by weight, based on the total weight of said mixture. In certain embodiments, the hydrophobic fluoropolymer is present at a level of about 10% by weight to about 40% by weight, based on the total weight of said mixture. In certain embodiments, the hydrophobic fluoropolymer is present at a level of about 10% by weight to about 30% by weight, based on the total weight of said mixture. In certain embodiments, the hydrophobic fluoropolymer has a degree of polymerization of about 2 to about 10, preferably, about 2 to about 5.

In certain embodiments, the chemically bonded treatment portion has a fluorine content of about 0.01% by weight to about 1% by weight, based on the total weight of said chemically bonded treatment portion.

In certain embodiments, the hydrophilic polymer is formed from at least one monomer selected from the group consisting of vinyl acetate, substituted vinyl acetate, C₁-C₆ alkyl(meth)acrylate, substituted C₁-C₆ alkyl(meth)acrylate, and combinations thereof. In certain embodiments, the hydrophilic polymer is ethylene-vinyl acetate.

In certain embodiments, the hydrophobic fluoropolymer has a degree of polymerization of about 2 to about 10. In certain embodiments, the hydrophobic fluoropolymer has a degree of polymerization of about 2 to about 5.

In certain embodiments, the hydrophobic fluoropolymer comprises residues of at least one C₆-C₁₆ fluorine-containing monomer, or a linear or branched congener thereof. In certain embodiments, the hydrophobic fluoropolymer comprises residues of at least one C₆-C₁₆ perfluoroalkyl-containing monomer, or a linear or branched congener thereof. In certain embodiments, the hydrophobic fluoropolymer further comprises residues selected from the group consisting of C₆-C₁₆ perfluoroalkyl-containing vinyl alcohol, C₆-C₁₆ perfluoroalkyl-containing (meth)acrylate, and combinations thereof.

In certain embodiments, the chemically bonded treatment portion comprises at least one compound

having a moiety reactive with a hydroxyl group on said cellulosic material and;

having a hydrophobic organofluorine moiety.

In certain embodiments, the moiety reactive with a hydroxyl group comprises a residue of at least one monomeric unit selected from the group consisting of vinyl acetate, substituted vinyl acetate, C₁-C₆ alkyl(meth)acrylate, substituted C₁-C₆ alkyl(meth)acrylate, and combinations thereof. In certain embodiments, the hydrophobic organofluorine moiety comprises a residue of at least one monomeric unit selected from the group consisting of C₆-C₁₆ perfluoroalkyl-containing monomers, and combinations thereof.

The article described herein may be in the form of a garment, such as a shirt, pants, and especially an active wear garment, where fast drying of perspiration is beneficial. The article described herein may also be in the form of an undergarment, such as socks or underwear. The article may also be in the form of linen, such a bedding, sheets, blankets, and the like, or a drying or washing article, such as a towel or washcloth, or cleaning, or drying article. The article may comprise fabric as described herein, or may be made essentially of the fabric described herein.

In some embodiments, the fabric described herein may comprise additional materials, such as a coating or treatment, or fibers or yarns for additional functionality, such as an antimicrobial agent, an odor control agent, an odor absorbing agent, an antistatic agent, a ultraviolent finish, a wrinkle resistance agent, an insect repellent, fabric sun protection, and a combination thereof. In one embodiment, the fabric described herein comprises no more than about 10% by weight odor control material, such as a coating, treatment, fiber, or yarns. In another embodiment, the fabric described herein comprises no more than about 15% by weight stretch fibers, filaments, or yarns. In yet another embodiment, the fabric described herein comprises no more than about 15% by weight structural fibers, filaments or yarns such as nylon for improved abrasion resistance and structural integrity. In still another embodiment, the fabric described herein comprises no more than about 7% by weight static control, or antistatic material, such as a coating, treatment, fiber, filament or yarn. In still another embodiment, the fabric described herein comprises no more than about 7% by weight antimicrobial material, such as a coating, treatment, fiber, filament, or yarn. Antimicrobial material may include siloxane, silver containing materials or compounds, or quaternary ammonium, for example.

The present invention is further defined in the following Examples, in which all parts and percentages are by weight, unless otherwise stated. It should be understood that these examples, while indicating preferred embodiments of the invention, are given by way of illustration only and are not to be construed as limiting in any manner. From the above discussion and these examples, one skilled in the art can ascertain the essential characteristics of this invention, and without departing from the spirit and scope thereof, can make various changes and modifications of the invention to adapt it to various usages and conditions.

### EXAMPLES

### Test Methods

### Average Values

The sample sheets tested herein were tested prior to washing, after 10, 20, and 30 wash cycles. When an average value is reported herein, it is the average of the prewash value, and the values measured or calculated after the 10, 20 and 30 was cycles.

### Water Weight Gain

The initial weight of the fabric was measured after remaining in a conditioned environment for at least 12 hours, but before the fabric was submerged in water, sandwiched between AATCC blotting paper, and passed through a padding roll with at 0.05 MPa pressure. The initial weight before submersion and the weight after the padding step were used to calculate Water Weight Gain in percent where:

$$Water Weight Gain \% = 100 \times \frac{( \begin{matrix}( weight after padder ) - \\ ( initial weight )\end{matrix} )}{( initial weight )}$$

### Water Release Rate (WRR)

Fabric was tested in accordance with a modified version of the provisional AATCC Gravimetric Drying Test Method (AATCC/MM TS-05) using multiple scales and multiple sample measurements for better accuracy of sample weights.

### Comfort WRR

The Comfort WRR was measured in accordance with a modified version of the provisional AATCC Gravimetric Drying Test Method (AATCC/MM TS-05) using multiple scales and multiple sample measurements for better accuracy of sample weights.

### Horizontal Wicking

Horizontal wicking time of materials made according to the present invention as well as comparative materials and control materials were measured according to Absorbency of Textile (Test Method AATCC 79 Absorbency of Textile). Horizontal wicking may be performed on a fabric or on yarns of a fabric as described in the test method.

### Dry Time

Dry Time of materials made according to the present invention as well as comparative materials and control materials may be tested in accordance with:

Modified version of the provisional AATCC Gravimetric Drying Test Method (AATCC/MM TS-05);

Durability testing—wash cycles as described in AATCC 135 versus WRR.

Differential Scanning calorimetry—modified test protocol used to determine energy required to dry water from fabrics at body temperature (37° C.)

IR or ATC

### Example 1

### Cotton Knit

A uniform fabric was treated with a treatment as described herein. A 4.8 oz/sq yd jersey knit fabric available from Swisstex, Los Angeles, Calif., was cut into about 20.3 cm by 40.6 cm sheets. One sheet was designated as a control and the other samples were treated with various concentrations of the treatment. All of the sheet were placed into a conditioned environment of 70F/65% RH for 12 hours and then individually weighed. The control sheet was saturated with water and subsequently passed through a padder. The control sample was weighed and the water weight gain was calculated. The nip pressure was adjusted as necessary, until a control sheet had a water weight gain of 65% to 70%. The pressure level in the nip of the padder was about 0.4 to 0.6 MPa, which was sufficient to remove any excess water not able to be absorbed completely into the fabric, yarn, and fibers. The nip pressure was then fixed for all subsequent treatments of the fabric.

A treatment formulation was prepared for Example 3 by combining in a glass beaker, water, a chemically bonded treatment portion, and a hydrophobic particle treatment portion. The chemically bonded treatment portion was RAINOFF® SRL-1, available from Eastern Chemical Co. Providence, R.I. Example 3 was prepared by adding 14.29 g of the chemically bonded treatment portion to 181.20 ml of water (see Example 3). The hydrophobic particle portion was a PTFE dispersion, DX9025 from Daikin America Inc. Orangeburg, N.Y. Approximately 0.94 g of the hydrophobic particle portion, having a percent solids of about 60% by weight solution, was added to the beaker of water containing the chemically bonded treatment portion. Approximately 3.57 g of magnesium chloride was added to the formulation. The formulation was mixed by a magnetic stirrer for approximately 10 to 12 minutes to create the treatment formulation. Other textile auxiliary finishes and/or additives may be added to the formulation such as, for example, softeners, antimicrobial agents, resins, binders, antistatic agents, and the like. In addition, other products may be substituted for the chemically bonded portion treatment in this example and many suppliers make equivalent hydrophobic particles.

Each sheet of fabric was submerged in the specific treatment formulation and then passed through the padder and the weight gain was calculated. The treated sample was then placed in a convection oven set to a temperature of 250° F. for approximately 4 minutes. The sample sheet was then removed from the oven and the oven temperature was increased to 300° F. When the oven reached 300° F., the sample sheet was placed back into the oven for approximately 2 minutes.

All samples were then conditioned in an environmentally controlled room overnight, where the relative humidity was approximately 65%, the temperature was approximately 70° F.

This process was repeated with chemically bonded treatment portion formulation of Examples 1, 2, and 4 containing 2%, 3.5% and 10% of chemically bonded portion respectively.

The control fabric sheet and all treated fabric sheets where tested per the test methods described herein.

### Example 2

### Cotton Woven

The treatment process as described in the Cotton Knit example was followed to make the treated woven cotton samples. The woven cotton fabric used was a 2.9 oz/yd2 plain weave available from Jo-Ann Fabrics Inc. The control fabric sheet and all treated fabric sheets where tested per the test methods described herein.

### Example 3

### 50/50 Polyester/Cotton Knit

The treatment process as described in the Cotton Knit example was followed to make the treated 50/50 polyester/cotton fabric samples. The 50/50 polyester/cotton fabric used was a 4.8 oz/yd2 plain jersey knit available from Swisstex. The control fabric sheet and all treated fabric sheets where tested per the test methods described herein.

### Comparative Example Fabric A

### DWR Treated

The cotton knit fabric described in the Cotton Knit example was treated with a 5% concentration durable water repellant (DWR) finish—UNIDYNE TG 581, available from Daikin, Orangeburg, N.Y. A 5% solution of the DWR was created by adding 42.86 g, of the TG-581 to 547.14 ml of water. The sample sheet was submerged in the solution, padded to allow for at least about 70% by weight, based on the weight of the solution, and dried according to the cotton knit example procedure. The comparative fabric A sheet was tested per the test methods described herein.

### Comparative Example B

### Transdry from Cotton Inc.

The comparative example was prepared by cutting samples of transDRY™ fabric available from Cotton Incorporated, Cary, N.C.

### Results and Discussion:

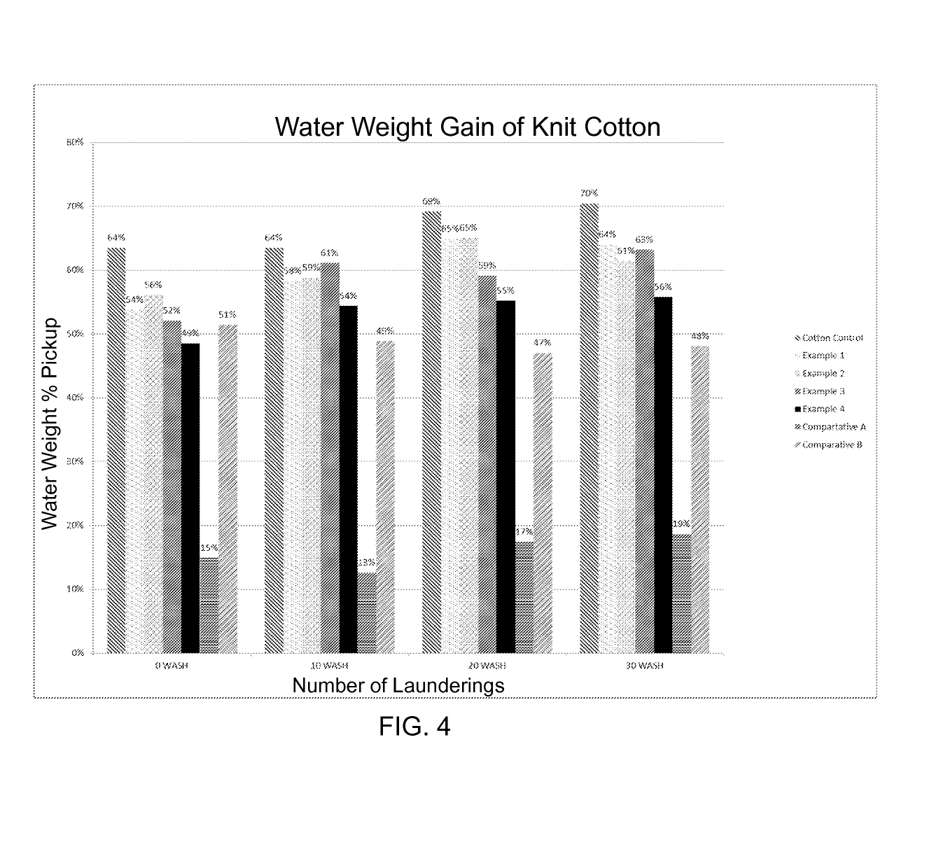

The fabric described herein has a unique combination of properties that makes it well suited for applications where high rates of moisture wicking and drying are desired. The fabric described herein is hydrophilic and can absorb a high percentage of water, and is fast drying. As shown in FIG. 4, the water weight gain percentage of the cotton knit control and the fabric treated as described herein had very similar water weight gain percentages. The fabric of Example 3 had an average of 59% water weight gain, and the cotton knit control fabric had an average of 67%. The comparative fabric A had an average water weight gain of only 16% and comparative fabric B only 49%. This high water weight gain demonstrates that the fabric described herein had similar water absorption to that of natural cotton knit control fabric.

Table 1 shows that the treated samples as described herein could be made to have a horizontal wicking time of no more than 8 seconds. The comparative fabric A had a horizontal wicking time of more than 100 seconds and would not be considered to be hydrophilic as described herein.

TABLE 1
Horizontal Wicking Times Knit Samples

Number of
Wash Cycles

| Samples | 0 | 10 | 20 | 30 |
|---|---|---|---|---|
| Knit Cotton (control) | 0 | 0 | 0 | 0 |
| Example 1 | 2 | 0 | 0 | 0 |
| Example 2 | 3 | 0 | 0 | 0 |
| Example 3 | 5 | 0 | 0 | 0 |
| Example 4 | 10 | 0 | 0 | 0 |
| Comparative A | 100 | 100 | 100 | 100 |
| Comparative B | 3 | 0 | 0 | 0 |

Table 2 shows the performance measured for comparative fabric B. Comparative example B had lower comfort and total WRR rates than the treated knit fabrics described herein.

TABLE 2
Comparative Fabric B

| | Comfort Zone | Total WRR | Comfort Zone | |
|---|---|---|---|---|
| | WRR (% per | (% per | Dry Time | Total Dry Time |
| | min) | min) | (min) | (min) |
| 0 wash | 0.43 | 0.66 | 42.9 | 75.5 |
| 10 wash | 0.42 | 0.59 | 44.6 | 80.5 |
| 20 wash | 0.38 | 0.58 | 49.4 | 79.5 |
| 30 wash | 0.37 | 0.56 | 50.1 | 83.1 |

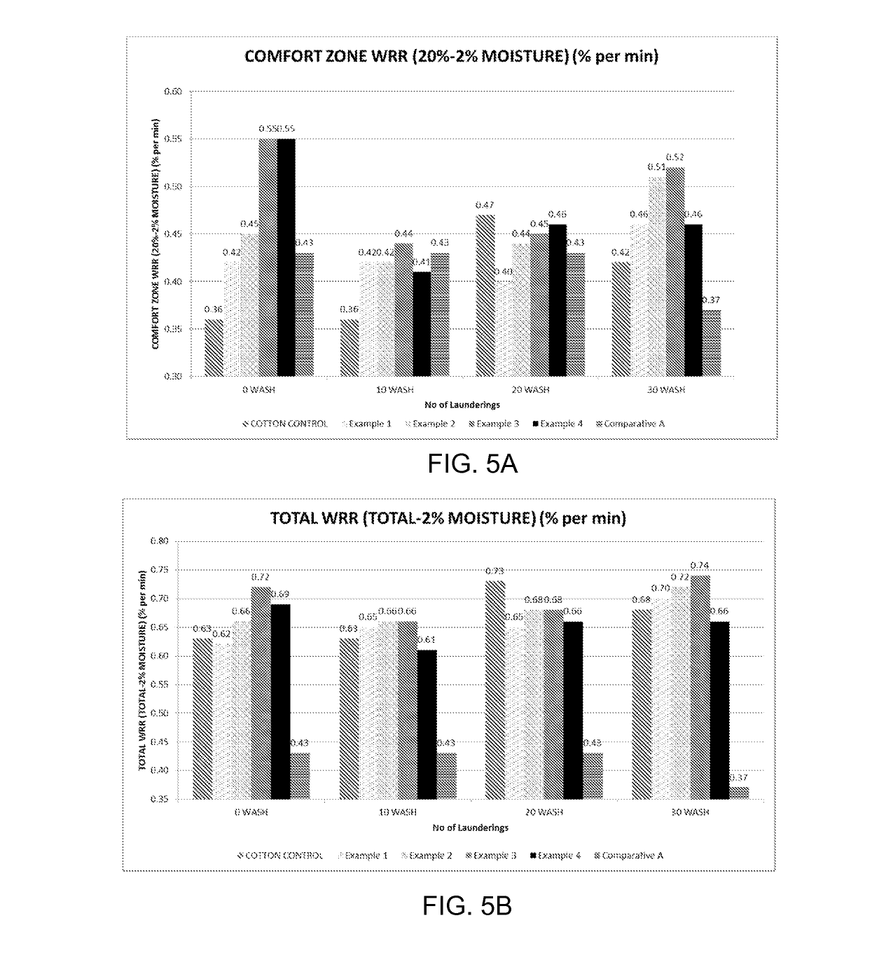

As shown in FIG. 5A and TABLE 2, the comfort zone WRR of the treated knit fabrics described herein was much higher than that of the cotton knit control fabric throughout most of the wash cycle testing. The average comfort zone WRR was only 0.4%/min for the cotton knit control, and 0.49%/min for the Example 3 fabric. This is a dramatic increase in water release rate. This high water release rate combined with a high water weight gain make the fabric described herein unique. The comfort zone WRR of comparative material A and B were on average very similar to the cotton knit control fabric, having a comfort zone WRR of 0.42%/min, 0.40%/min respectively, compared to the cotton knit control fabric of 0.4%/min. The total WRR for the comparative fabric A and the comparative fabric B was 0.42%/min, and 0.60%/min, whereas the total WRR for the cotton knit control fabric was 0.67%/min. The total WRR for the cotton knit control fabric was significantly higher than either of the two comparative materials.

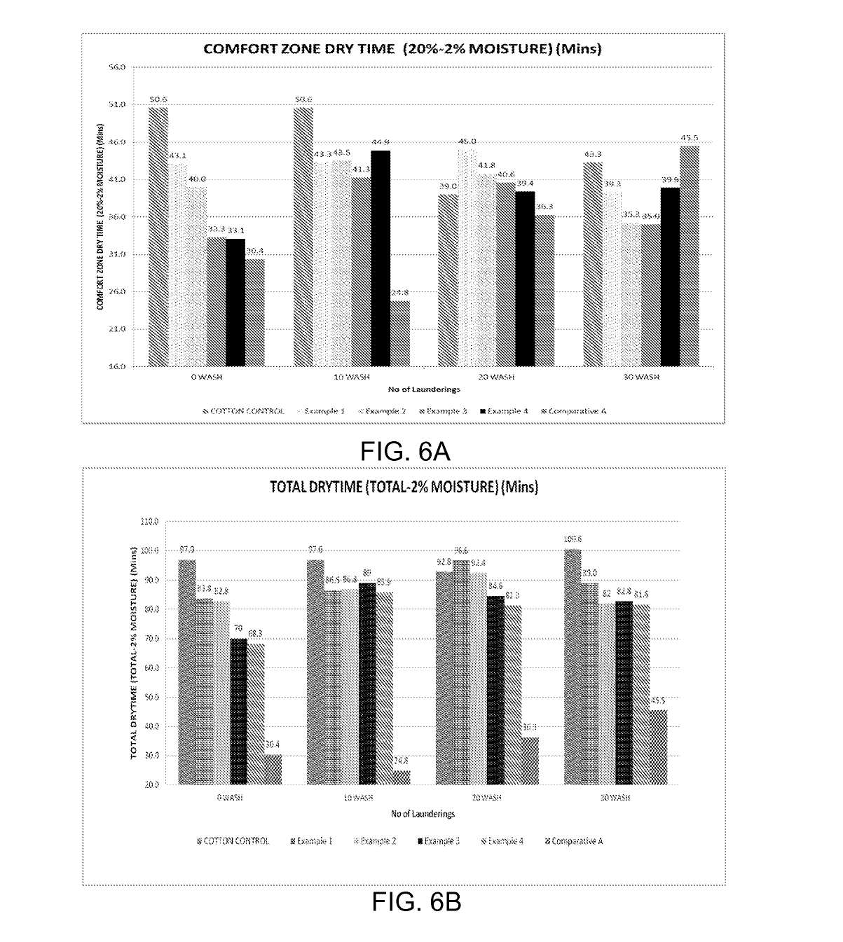

As shown in FIGS. 6A and 6B the drying time of the treated knit fabrics described herein were lower than the cotton knit control fabric over most of the wash cycles. For example, the average comfort zone dry time, averaged over all wash cycles, of the cotton knit control was 46 minutes, and the average dry time of the Example 3 fabric was only 38 minutes. The cotton knit control fabric took approximately 22% longer to dry than the fabric described herein. The reduced drying time of the treated fabrics described herein makes them an energy efficient material, as these inventive fabrics can absorb a high amount of water and rapidly dry.

As shown in FIGS. 6A, 6B and Table 2, the drying time of the comparative fabric A, was much lower that either the comparative fabric B or the cotton knit control. The average comfort zone drying time for the comparative fabric A was approximately 34 minutes and approximately 46 minutes for both the comparative fabric B and the cotton knit control. Likewise, the average total drying time for comparative fabric A was approximately 34 minutes and approximately 97 minutes for the cotton knit control and approximately 80 minutes for the comparative B fabric. The comparative fabric A only had an average water weight gain of approximately 16%, which is why the drying times were so low. Therefore, comparative fabric A may dry quickly, but this is in part due to the low water absorption properties of fabric.

The comfort score of a fabric is a measure of a fabric's ability to absorb water combined with the fabric's ability to dry quickly. The comfort score is the ratio of the water weight gain percent over the comfort zone dry time in minutes. The comfort score reported herein is calculated for the fabrics before washing. Table 3 shows calculated comfort score for the treated knit cotton fabrics described herein, the cotton knit control fabric, and the two comparative knit fabric samples. In addition, Table 3 shows the percent improvement in comfort score over the cotton knit control sample. The fabric sample of Example 3 had a 24.7% improvement in comfort score over the cotton knit control sample. The two comparative fabric samples A and B had much lower comfort scores than the control fabric.

TABLE 3
Comfort Score Knit Cotton

| | % Water | Comfort Dry | Comfort | |
|---|---|---|---|---|
| | Weight Gain | Time | Score | % Improvement |
| Control | 63.5% | 50.6 | 0.0125 | |
| Example 1 | 53.8% | 43.1 | 0.0125 | 0% |
| Example 2 | 56.1% | 40.0 | 0.0140 | 11.8% |
| Example 3 | 52.1% | 33.3 | 0.0156 | 24.7% |
| Example 4 | 48.5% | 33.1 | 0.0147 | 16.8% |
| Comparative A | 14.9% | 30.4 | 0.0049 | −60.9% |
| Comparative B | 51.4% | 42.9 | 0.0120 | −4.5% |

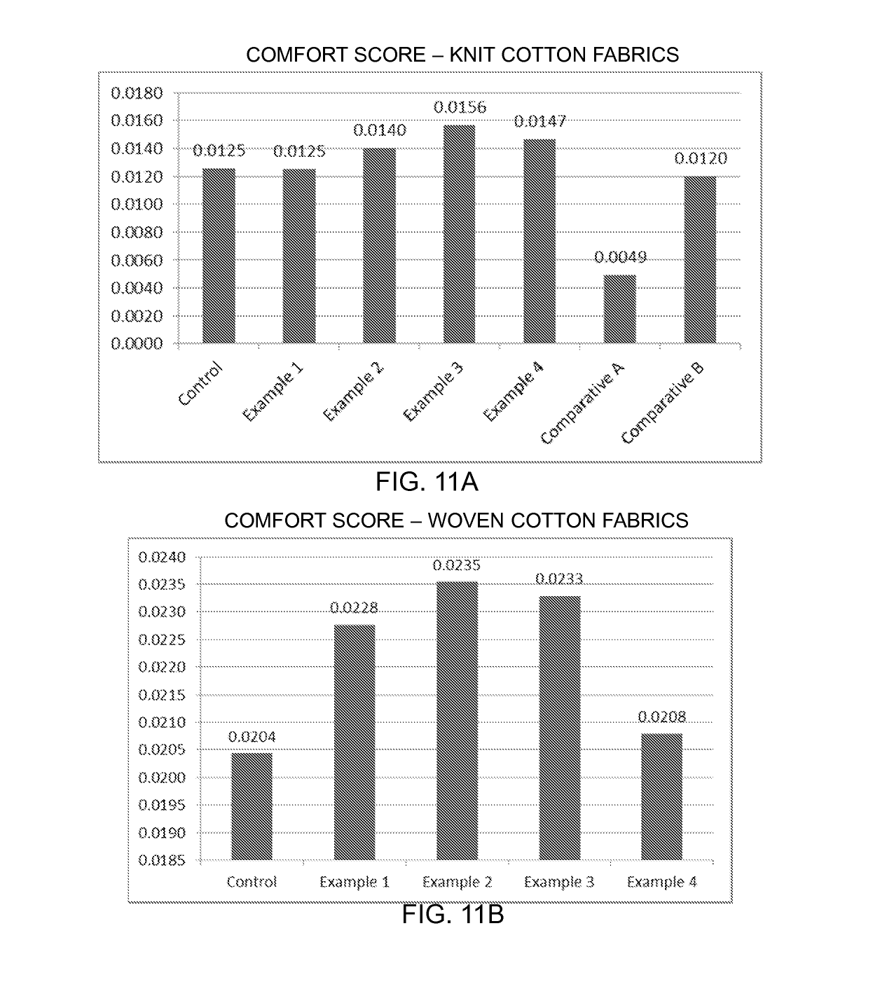

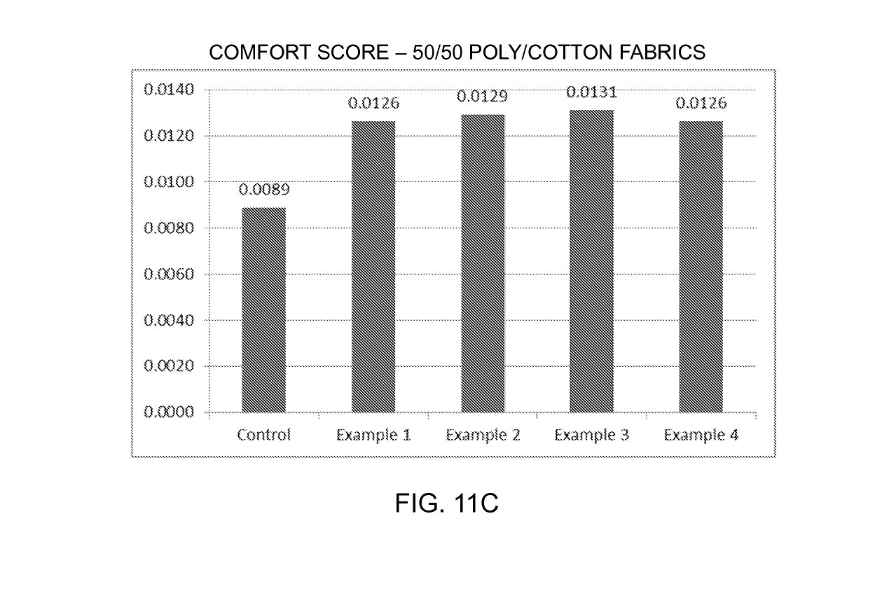

FIG. 11A shows the comfort score of the knit fabrics described herein. The graph shows that there is an optimum concentration where the comfort score is maximized. The Example 3 treatment concentration gave the highest comfort score than the cotton knit control fabric. The optimum concentration was between Example 2 and Example 4, with a maximum observed value at the concentration of Example 3.

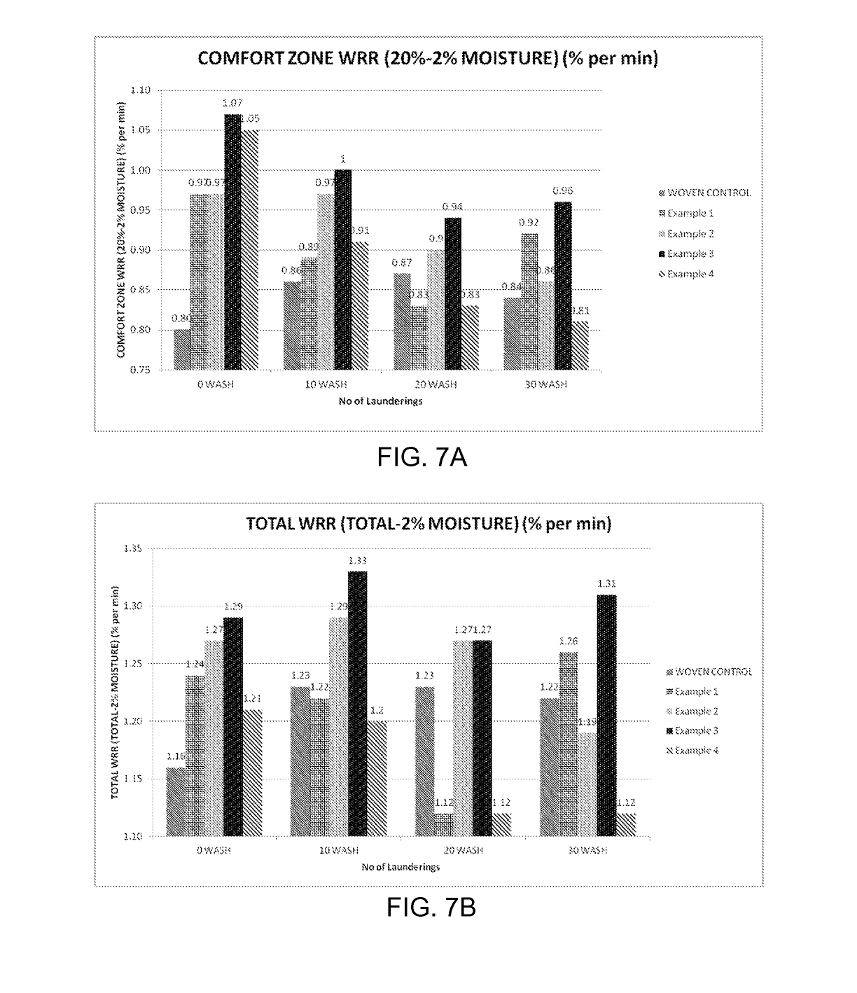

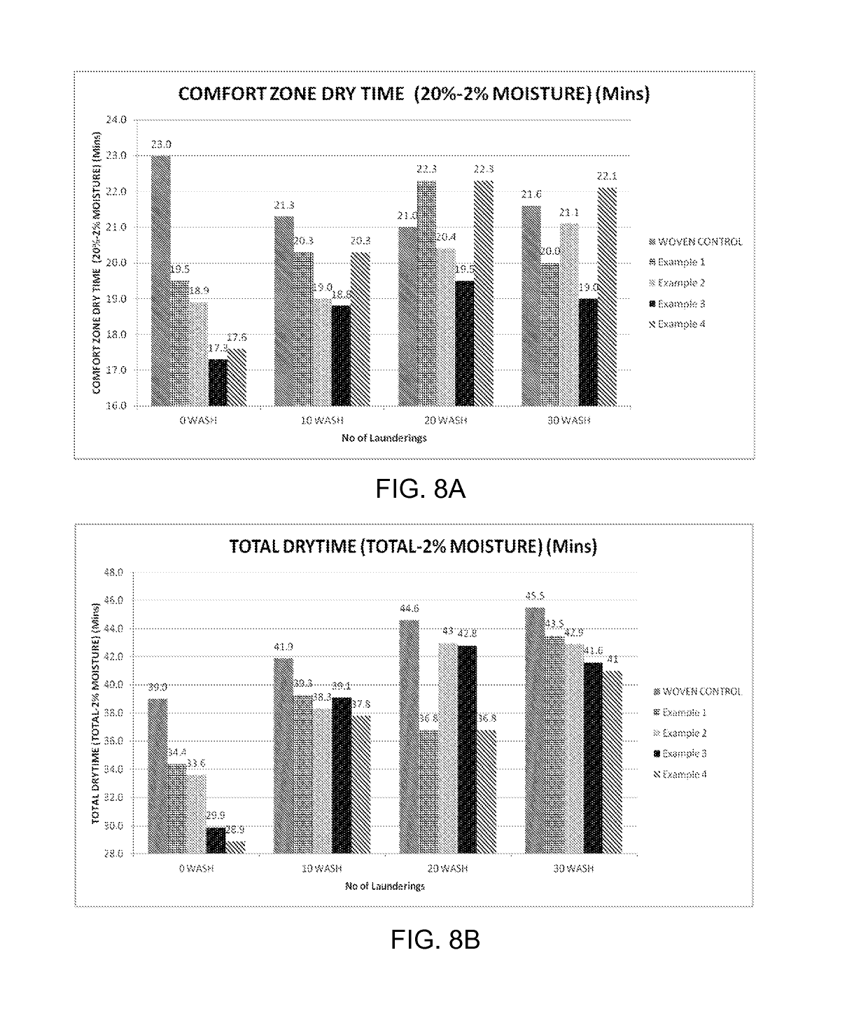

The water weight gain of the woven cotton control fabric along with the fabrics made as described herein is provided in Table 4. As shown, the treated fabrics of Examples 2 and 3 had less than 5% less water weight gain than the woven cotton control. Both the comfort and total WRR were highest for the fabric sample of Example 3 as shown in FIG. 7A and FIG. 7B. In addition, as shown in FIG. 8A and FIG. 8B, the comfort drying time of the woven cotton control was approximately 16% longer than the Example 3 fabric sample. The average comfort drying times for the Example 3 fabric, and the woven cotton control fabric was 18.7 minutes and 21.7 minutes respectively. The horizontal wicking times of the woven samples is provided in Table 4. The horizontal wicking time of the Example 3 fabric was the lowest out of all of the fabric samples including the woven cotton control fabric.

TABLE 4
Water Weight Gain and Average Horizontal of Woven Fabrics

| | Water Weight | Horizontal |
|---|---|---|
| Material | Gain % | Wicking (sec) |
| Woven Cotton | 53.5% | 0.7 |
| Example 1 | 48.4% | 1.3 |
| Example 2 | 51.3% | 5.0 |
| Example 3 | 51.6% | 0.0 |
| Example 4 | 43.7% | 0.3 |

Table 5 shows the comfort score for the treated woven cotton fabrics described herein and the woven cotton control sample. In addition, Table 5 shows the percent improvement in comfort score over the woven cotton control sample. The fabric sample having a Example 2 had approximately a 16% improvement in comfort score over the control sample. FIG. 11B graphically shows that there is an optimum treatment concentration for maximizing comfort score of the woven fabric samples. The optimum is between Example 1 and Example 3, with a maximum observed value at the concentration of Example 2.

TABLE 5
Comfort Score Woven Cotton

| | % Water | Comfort Dry | Comfort | % |
|---|---|---|---|---|
| | Weight Gain | Time | Score | Improvement |
| Control | 47.0% | 23.0 | 0.0204 | |
| Example 1 | 44.4% | 19.5 | 0.0228 | 11.4% |
| Example 2 | 44.5% | 18.9 | 0.0235 | 15.2% |
| Example 3 | 40.3% | 17.3 | 0.0233 | 14.0% |
| Example 4 | 36.6% | 17.6 | 0.0208 | 1.8% |

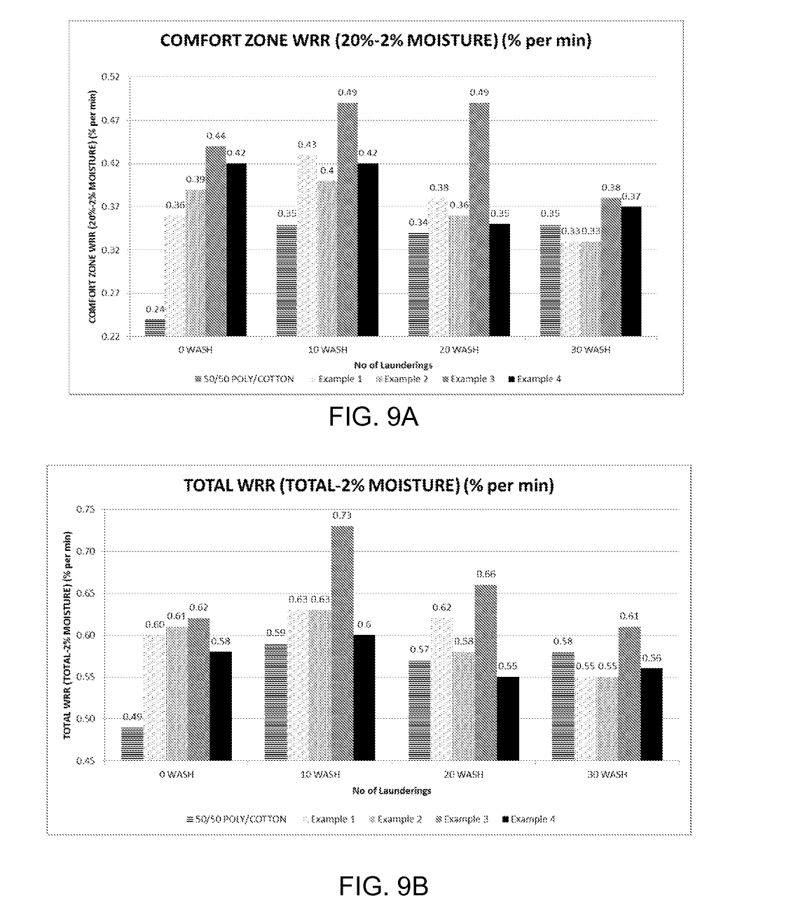

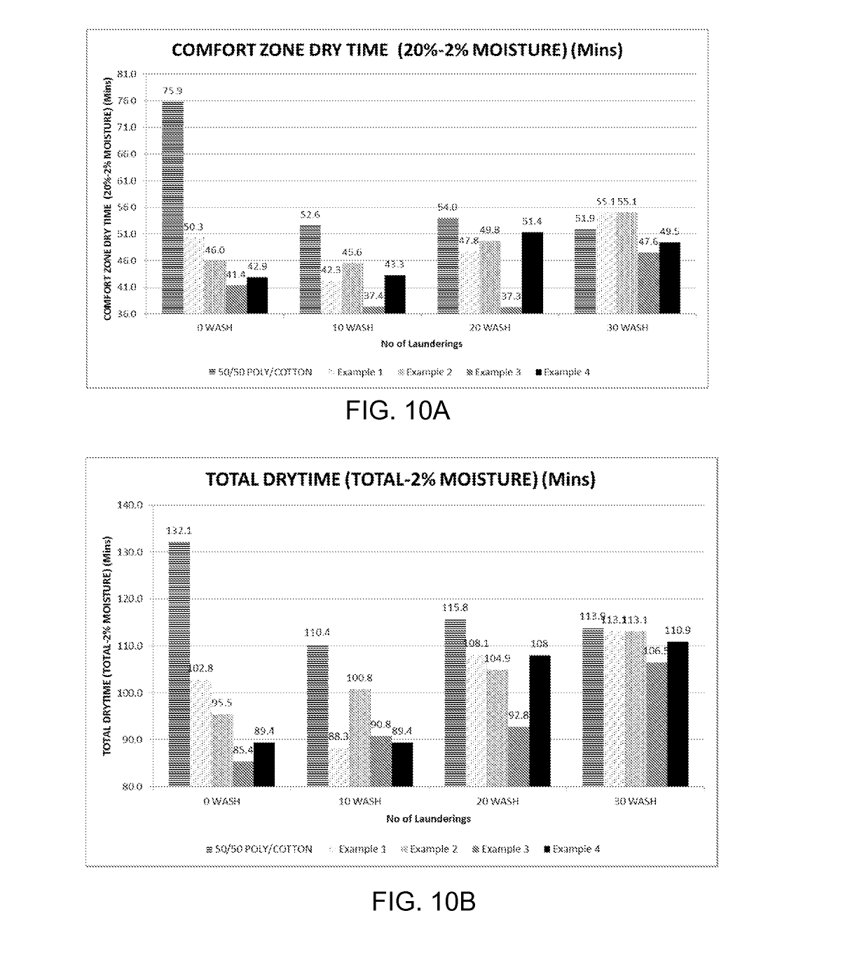

As shown in FIG. 9A and FIG. 9B, the 50/50 polyester/cotton fabric having the Example 3 treatment concentration as described herein, had a much higher comfort and total WRR than the 50/50 polyester/cotton control. The Example 3 fabric was consistently the highest performing sample, and on average had approximately a 44% higher comfort WRR than the 50/50 polyester/cotton control. Referring to FIGS. 10A and 10B, the Example 3 sample had consistently the lowest comfort and total dry times. The water weight gain and horizontal wicking data for the treated 50/50 polyester/cotton fabrics as well as the 50/50 polyester/cotton control is provided in Table 6. All of the treated 50/50 polyester/cotton fabrics had a horizontal wicking time of less than 8 seconds, and would be considered hydrophilic as defined herein.

TABLE 6
50/50 Polyester/Cotton Data

| | Water Weight Gain % | Horizontal Wicking (sec) |
|---|---|---|
| Control | 67.8% | 0 |
| Example 1 | 63.4% | 0.75 |
| Example 2 | 63.0% | 1 |
| Example 3 | 63.0% | 1.5 |
| Example 4 | 58.8% | 3 |

Table 7 shows the comfort score for the treated 50/50 polyester/cotton fabrics described herein, and the 50/50 polyester/cotton control sample. In addition, Table 7 shows the percent improvement in comfort score over the control sample. The fabric sample having Example 3 had approximately a 47.9% improvement in comfort score over the control sample. FIG. 11C graphically shows that there is an optimum treatment concentration for maximizing comfort score of the woven fabric samples. The optimum is between Example 2 and Example 4, with a maximum observed value at the concentration of Example 3.

TABLE 7
Comfort Score 50/50 Polyester/Cotton Fabric

| | % Water | Comfort | Comfort | |
|---|---|---|---|---|
| | Weight Gain | Dry Time | Score | % Improvement |
| Control | 67.3% | 75.9 | 0.0089 | |
| Example 1 | 63.6% | 50.3 | 0.0126 | 42.6% |
| Example 2 | 59.5% | 46.0 | 0.0129 | 45.9% |
| Example 3 | 54.3% | 41.4 | 0.0131 | 47.9% |
| Example 4 | 54.2% | 42.9 | 0.0126 | 42.5% |

The fabric described herein may be fast drying as defined herein. The percent improvement in comfort zone dry time may be greater than 10%. As shown in Table 8, the treated knit fabric of Examples 1, 2, and 4 all had greater than a 10% improvement in the average comfort zone drying time over the cotton knit control fabric with a maximum observed value at the concentration of Example 3. The comparative fabric A has a greater than 10% improvement in drying time as well, however, this sample does not have as high of a water weight gain and does not wick. Comparative fabric B, had no improvement in average comfort zone drying time.

TABLE 8
Knit Cotton Fabric, Fast Drying

| | Comfort Zone Dry Time | % Improvement in |
|---|---|---|
| | (min) | Comfort Zone Dry Time |
| Control | 45.88 | |
| Example 1 | 42.68 | 7.0 |
| Example 2 | 40.15 | 12.5 |
| Example 3 | 37.55 | 18.2 |
| Example 4 | 39.33 | 14.3 |
| Comparative A | 34.25 | 25.3 |
| Comparative B | 46.75 | −1.9 |

Table 9 shows that the Example 3 treated woven fabric described herein had a 14.3% improvement in comfort zone drying time over the woven control sample and would be considered fast drying as defined herein.

TABLE 9
Woven Cotton Fabric Fast Drying

| | | % Improvement in |
|---|---|---|
| | Comfort Zone Dry Time | Comfort Zone Dry |
| | (min) | Time |
| Woven Cotton Control | 21.7 | |
| Example 1 | 20.5 | 5.5 |
| Example 2 | 19.9 | 8.6 |
| Example 3 | 18.7 | 14.2 |
| Example 4 | 20.6 | 5.3 |

Table 10 shows that all of the treated 50/50 polyester/cotton fabric samples described herein had at least a 10% improvement in comfort zone dry time over the control, and would be considered fast drying as defined herein.

TABLE 10
50/50 Polyester/Cotton Fabric: Fast Drying

| | Comfort Zone Dry Time | % Improvement in Comfort |
|---|---|---|
| | (min) | Zone Dry Time |
| Control | 58.6 | |
| Example 1 | 48.9 | 16.6 |
| Example 2 | 49.1 | 16.2 |
| Example 3 | 40.9 | 30.2 |
| Example 4 | 46.8 | 20.1 |

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed is:

1. An article of manufacture, comprising:
a fabric, comprising at least about 45%, by weight, based on the total weight of the fabric, of at least one cellulosic material;
a treatment to form a treated fabric, wherein said treatment comprises:
a hydrophobic particle treatment portion; and
a chemically bonded treatment portion;
wherein said treated fabric is hydrophilic and fast drying.

2. The article of claim 1,
wherein said fabric is constructed of a single compositional yarn.

3. The article of claim 1,
wherein said fabric further comprises at least one functional yarn.

4. The article of claim 3,
wherein said functional yarn is a yarn selected from the group consisting of an elastomeric yarn, an antistatic yarn, an anti-abrasion yarn, an antimicrobial yarn, a structural reinforcement yarn, and a combination thereof.

5. The article of claim 1, further comprising:
at least one functional additive, wherein said functional additive is selected from the group consisting of an antimicrobial agent, an odor control agent, an odor absorbing agent, an antistatic agent, a ultraviolent finish, a wrinkle resistance agent, an insect repellent, fabric sun protection, and a combination thereof.

6. The article of claim 1,
wherein said treatment is uniformly distributed on or in said fabric.

7. The article of claim 1,
wherein said treatment is distributed as a gradient in said fabric.

8. The article of claim 1,
wherein said treatment is present at a level less than sufficient to form a coating on said fabric.

9. The article of claim 1,
wherein said treatment is present at a level of less than about 5% by dry weight, based on the total weight of the fabric.

10. The article of claim 1,
wherein said fabric consists essentially of cellulosic material.

11. The article of claim 1,
wherein said fabric consists essentially of cotton.

12. The article of claim 1,
wherein said fabric further comprises at least one synthetic fiber.

13. The article of claim 1,
wherein said hydrophobic particle treatment portion comprises at least one material selected from the group consisting of polymer particles, metal particles, silica, and combinations thereof.

14. The article of claim 1,
wherein said hydrophobic particle treatment portion comprises a plurality of polymer particles, wherein said polymer particles comprise at least one polymer selected from the group consisting of fluoro-containing homopolymer, fluoro-containing copolymer, polyvinyl acetate, polyvinyl acetate/acrylic copolymer, and combinations thereof.

15. The article of claim 1,
wherein said hydrophobic particle treatment is formed from polytetrafluoroethylene.

16. The article of claim 1,
wherein said hydrophobic particle treatment is formed from one or more of polyvinyl acetate and a polyvinyl acetate/acrylic copolymer.

17. The article of claim 1,
wherein said hydrophobic particle treatment is formed from a combination of at least two of polytetrafluoroethylene, polyvinyl acetate, and a polyvinyl acetate/acrylic copolymer.

18. The article of claim 1,
wherein said hydrophobic particles have a diameter less than about 1 μm in diameter.

19. The article of claim 1,
wherein said hydrophobic particles have a diameter less than about 500 nm in diameter.

20. The article of claim 1,
wherein said chemically bonded treatment portion is formed from a mixture comprising:
at least one hydrophilic monomer or polymer having a moiety reactive with a hydroxyl group on said cellulosic material; and
at least one hydrophobic fluoropolymer or fluoromonomer.

21. The article of claim 20,
wherein said hydrophilic monomer or polymer having a moiety reactive with a hydroxyl group on said cellulosic material is present at a level of about 10% by weight to about 90% by weight, based on the total weight of said mixture.

22. The article of claim 20,
wherein said hydrophilic monomer or polymer having a moiety reactive with a hydroxyl group on said cellulosic material is present at a level of about 40% by weight to about 70% by weight, based on the total weight of said mixture.

23. The article of claim 20,
wherein said hydrophilic monomer or polymer having a moiety reactive with a hydroxyl group on said cellulosic material is present at a level of about 70% by weight to about 90% by weight, based on the total weight of said mixture.

24. The article of claim 20,
wherein said hydrophobic fluoropolymer or fluoromonomer is present at a level of about 10% by weight to about 90% by weight, based on the total weight of said mixture.

25. The article of claim 20,
wherein said hydrophobic fluoropolymer or fluoromonomer is present at a level of about 10% by weight to about 40% by weight, based on the total weight of said mixture.

26. The article of claim 20,
wherein said hydrophobic fluoropolymer or fluoromonomer is present at a level of about 10% by weight to about 30% by weight, based on the total weight of said mixture.

27. The article of claim 20,
wherein said chemically bonded treatment portion has a fluorine content of about 0.01% by weight to about 1% by weight, based on the total weight of said chemically bonded treatment portion.

28. The article of claim 20,
wherein said hydrophilic polymer or monomer is formed from at least one monomer selected from the group consisting of vinyl acetate, substituted vinyl acetate, C₁-C₆ alkyl(meth)acrylate, substituted C₁-C₆ alkyl(meth)acrylate, and combinations thereof.

29. The article of claim 20,
wherein said hydrophilic polymer is ethylene-vinyl acetate.

30. The article of claim 20,
wherein said hydrophobic fluoropolymer comprises residues of at least one C₆-C₁₆ fluorine-containing monomer, or a linear or branched congener thereof.

31. The article of claim 20,
wherein said hydrophobic fluoropolymer comprises residues of at least one C₆-C₁₆ perfluoroalkyl-containing monomer, or a linear or branched congener thereof.

32. The article of claim 31,
wherein said hydrophobic fluoropolymer further comprises residues selected from the group consisting of C₆-C₁₆ perfluoroalkyl-containing vinyl alcohol, C₆-C₁₆ perfluoroalkyl-containing (meth)acrylate, and combinations thereof.

33. The article of claim 1,
wherein said chemically bonded treatment portion comprises at least one compound:
having a moiety reactive with a hydroxyl group on said cellulosic material and;
having a hydrophobic organofluorine moiety.

34. The article of claim 33,
wherein said moiety reactive with a hydroxyl group comprises a residue of at least one monomeric unit selected from the group consisting of vinyl acetate, substituted vinyl acetate, C₁-C₆ alkyl(meth)acrylate, substituted C₁-C₆ alkyl(meth)acrylate, and combinations thereof.

35. The article of claim 34,
wherein said hydrophobic organofluorine moiety comprises a residue of at least one monomeric unit selected from the group consisting of C₆-C₁₆ perfluoroalkyl-containing monomer, and combinations thereof.

36. The article of claim 1,
wherein the chemically bonded treatment portion comprises a bonded end and an extended end, wherein said extended end comprises at least one fluorine atom.

37. The article of claim 1,
wherein the weight ratio of said hydrophobic particle treatment portion to said chemically bonded treatment portion is about 1:1 to about 1:50.

38. The article of claim 1,
wherein said article has a water weight gain of at least 40%.

39. The article of claim 1,
wherein the article has a horizontal wicking time of no more than about 8 seconds.

40. The article of claim 1,
wherein the article has an improvement of at least about 20% in comfort zone, in total WRR, and dry time compared to an untreated article.

41. The article of claim 1,
wherein said fabric is a woven fabric, a knit fabric, a non-woven fabric, or a combination thereof.

42. The article of claim 1,
wherein the article is a garment.

43. The article of claim 44,
wherein the garment is a shirt, an undergarment, or a sock.

44. The article of claim 1,
wherein the article is a linen.

45. The article of claim 1,
wherein the article is a drying article.

46. The article of claim 45,
wherein the drying article is a towel.

47. A process for producing an article, comprising:
providing a fabric;
wherein said fabric comprises at least about 45%, by weight, based on the total weight of the fabric, of at least one cellulosic material;
providing a hydrophobic particle treatment;
providing a chemical treatment;
wherein said chemical treatment comprises:
at least one hydrophilic polymer having a moiety reactive with a hydroxyl group on said cellulosic material;
at least one hydrophobic fluoropolymer; and
at least one optional catalyst;
treating said fabric with said hydrophobic particle treatment at a level of about 0.05% by weight of dried solids to about 2% by weight of dried solids, based on the total weight of the fabric, and said chemical treatment at a level of about 3% by weight to about 10% by weight, based on the total weight of the fabric, to form a treated fabric;
optionally, padding said treated fabric; and
optionally, curing said treated fabric.

48. The process of claim 47,
wherein said hydrophobic particle treatment and said chemical treatment are uniformly distributed on or in said fabric.

49. The process of claim 47,
wherein said hydrophobic particle treatment and said chemical treatment are distributed over a gradient in said fabric.

50. The process of claim 47,
wherein said hydrophobic particle treatment and said chemical treatment are conducted simultaneously.

51. A process of claim 47,
wherein said hydrophobic particle treatment and said chemical treatment are conducted sequentially.

52. A process of claim 47,
wherein said fabric is treated by said hydrophobic particle treatment and then by said chemical treatment.

53. A process of claim 47,
wherein said fabric is treated by said hydrophobic particle treatment after said chemical treatment.

54. The product produced by the process of claim 47.

55. The product produced by the process of claim 47;
wherein said product is hydrophilic and fast-drying.

56. A composition, comprising:
a. a plurality of hydrophobic particles;
b. at least one hydrophilic monomer or polymer having a moiety reactive with a hydroxyl group; and
c. at least one hydrophobic fluoropolymer or fluoromonomer.

57. The composition of claim 56, further comprising:
d. at least one catalyst.

58. The composition of claim 57,
wherein said catalyst is magnesium chloride, potassium chloride, antimony salt, or a mixture thereof.

59. The composition of claim 57,
wherein said plurality of hydrophobic particles comprises at least one material selected from the group consisting of polymer particles, metal particles, silica, and combinations thereof.

60. The composition of claim 57,
wherein said plurality of hydrophobic particles comprise at least one polymer selected from the group consisting of fluoro-containing homopolymer, fluoro-containing copolymer, polyvinyl acetate, polyvinyl acetate/acrylic copolymer, and combinations thereof.

61. The composition of claim 57,
wherein said plurality of hydrophobic particles are formed from polytetrafluoroethylene.

62. The composition of claim 57,
wherein said plurality of hydrophobic particles are formed from one or more of polyvinyl acetate and a polyvinyl acetate/acrylic copolymer.

63. The composition of claim 57,
wherein said plurality of hydrophobic particles are formed from a combination of at least two of polytetrafluoroethylene, polyvinyl acetate, and a polyvinyl acetate/acrylic copolymer.

64. The composition of claim 57,
wherein said plurality of hydrophobic particles have an average diameter less than about 1 μm.

65. The composition of claim 57,
wherein said plurality of hydrophobic particles have an average diameter less than about 500 nm.

66. The composition of claim 57,
wherein said hydrophilic polymer or monomer having a moiety reactive with a hydroxyl group is present at a level of about 10% by weight to about 90% by weight, based on the total weight of said components b and c.

67. The composition of claim 57,
wherein said hydrophilic polymer or monomer having a moiety reactive with a hydroxyl group is present at a level of about 40% by weight to about 70% by weight, based on the total weight of said components b and c.

68. The composition of claim 57,
wherein said hydrophilic polymer or monomer having a moiety reactive with a hydroxyl group is present at a level of about 70% by weight to about 90% by weight, based on the total weight of said components b and c.

69. The composition of claim 57,
wherein said hydrophobic fluoropolymer or fluoromonomer is present at a level of about 10% by weight to about 90% by weight, based on the total weight of said components b and c.

70. The composition of claim 57,
wherein said hydrophobic fluoropolymer or fluoromonomer is present at a level of about 10% by weight to about 40% by weight, based on the total weight of said components b and c.

71. The composition of claim 57,
wherein said hydrophobic fluoropolymer or fluoromonomer is present at a level of about 10% by weight to about 30% by weight, based on the total weight of said components b and c.

72. The composition of claim 57,
wherein said hydrophilic polymer or monomer having a moiety reactive with a hydroxyl group is formed from monomers selected from the group consisting of vinyl acetate, substituted vinyl acetate, C₁-C₆ alkyl(meth)acrylate, substituted C₁-C₆ alkyl(meth)acrylate, and combinations thereof.

73. The composition of claim 57,
wherein said hydrophobic fluoropolymer or fluoromonomer comprises residues of at least one C₆-C₁₆ fluorine-containing monomer, or a linear or branched congener thereof.

74. The composition of claim 57,
wherein said hydrophobic fluoropolymer or fluoromonomer comprises residues of at least one C₆-C₁₆ perfluoroalkyl-containing monomer, or a linear or branched congener thereof.

75. The composition of claim 74,
wherein said hydrophobic fluoropolymer or fluoromonomer further comprises residues selected from the group consisting of C₆-C₁₆ perfluoroalkyl-containing vinyl alcohol, C₆-C₁₆ perfluoroalkyl-containing (meth)acrylate, and combinations thereof.
